(19) United States
(12) Patent Application Publication
(10) Pub. No.: US 2025/0174728 A1
(43) Pub. Date: May 29, 2025

(54) SECONDARY BATTERY

(71) Applicant: Semiconductor Energy Laboratory Co., Ltd., Atsugi-shi (JP)

(72) Inventors: Shunpei YAMAZAKI, Setagaya (JP); Kazutaka KURIKI, Ebina (JP); Teruaki OCHIAI, Atsugi (JP); Tetsuya KAKEHATA, Isehara (JP)

(21) Appl. No.: 18/948,624

(22) Filed: Nov. 15, 2024

(30) Foreign Application Priority Data
Nov. 24, 2023 (JP) 2023-198879

(51) Int. Cl. H01M 10/0585; H01M 4/02; H01M 4/38; H01M 4/583; H01M 10/0569

(52) U.S. Cl. CPC H01M 10/0585; H01M 4/382; H01M 4/386; H01M 4/583; H01M 10/0569; H01M 2004/027

(57) ABSTRACT

A secondary battery where an internal short circuit due to a dendrite is prevented is provided. The secondary battery includes a negative electrode active material layer, a separator, a carbon sheet placed between the negative electrode active material layer and the separator, a dendrite between the negative electrode active material layer and the carbon sheet, and a positive electrode active material layer. The negative electrode active material layer contains a negative electrode active material. The negative electrode active material contains one or more selected from graphite and silicon. The thickness of the carbon sheet is greater than or equal to 25 nm and less than or equal to 50 μm. The dendrite has a portion along a plane of the carbon sheet. The carbon sheet preferably contains a carbon nanotube.

### BACKGROUND OF THE INVENTION

### 1. Field of the Invention

The present invention relates to a secondary battery. Note that the present invention is not limited to the above field and may relate to a semiconductor device, a display device, a light-emitting device, a power storage device, a lighting device, an electronic device, a vehicle, and manufacturing methods thereof. For example, the secondary battery of the present invention can be used as a power supply necessary for the above semiconductor device, display device, light-emitting device, power storage device, lighting device, electronic device, and vehicle. The above electronic device may be an information terminal device provided with the secondary battery. The above power storage device may be a stationary power storage device, for example.

### 2. Description of the Related Art

Recently, demand for lithium-ion secondary batteries with high output and high capacity has rapidly grown with the development of the semiconductor industry. The lithium-ion secondary batteries are essential as rechargeable energy supply sources for today's information society.

A lithium-ion secondary battery has a problem in that a lithium dendrite is generated on a negative electrode when charging and discharging are repeated. A lithium dendrite is a tree-like crystal of a lithium metal that grows in the charging and discharging process, and is generated by concentration of current in an uneven portion of the negative electrode surface, for example. When a lithium dendrite reaches a positive electrode, the lithium-ion secondary battery might have an internal short circuit, which reduces the reliability of the lithium-ion secondary battery.

Graphite is often used as a negative electrode material, and the use of a lithium metal instead of graphite is expected to increase the capacity of a lithium-ion secondary battery. In the case of using graphite, a lithium dendrite is likely to be generated when charging and discharging are performed at low temperature, and in the case of using a lithium metal, a lithium dendrite is likely to be generated even when charging and discharging are performed at normal temperature.

In order to inhibit such a lithium dendrite, a secondary battery using an inorganic salt containing fluorine as an electrolyte solution has been proposed (see Patent Document 1).

### REFERENCE

### Patent Document

[Patent Document 1] Domestic Re-Publication of PCT International Publication for Patent Application No. 2015-145288

### SUMMARY OF THE INVENTION

However, in the structure of Patent Document 1, an inorganic salt containing fluorine needs to be used as the electrolyte solution; thus, the electrolyte solution cannot be freely selected. For example, it is difficult to select an electrolyte solution suitable for operation in a low-temperature environment. In view of the above, an object of the present invention is to provide a secondary battery having a novel structure for reducing the influence of a dendrite.

Note that the description of these objects does not preclude the existence of other objects. In one embodiment of the present invention, there is no need to achieve all the objects. Other objects can be derived from the descriptions of the specification, the drawings, the claims, and the like.

In view of the above objects, the present inventors have found a novel structure for controlling a growth direction of a dendrite generated on a negative electrode. In the novel structure, a carbon sheet is provided between the negative electrode where a dendrite is generated and a separator. With this structure, an internal short circuit of a secondary battery can be prevented, and the reliability of the secondary battery is improved.

One embodiment of the present invention is a secondary battery including a negative electrode active material layer, a separator, a carbon sheet placed between the negative electrode active material layer and the separator, a dendrite between the negative electrode active material layer and the carbon sheet, and a positive electrode active material layer. The negative electrode active material layer contains a negative electrode active material. The negative electrode active material contains one or more selected from graphite and silicon. The thickness of the carbon sheet is greater than or equal to 25 nm and less than or equal to 50 μm. The dendrite has a portion along a plane of the carbon sheet.

In the present invention, it is preferable that the secondary battery further include an electrolyte solution and the electrolyte solution contain FEC and MTFP.

In the present invention, it is preferable that the secondary battery further include an electrolyte solution and the electrolyte solution contain ethylene carbonate, ethyl methyl carbonate, and dimethyl carbonate.

Another embodiment of the present invention is a secondary battery including a negative electrode active material layer, a separator, a carbon sheet placed between the negative electrode active material layer and the separator, a dendrite between the negative electrode active material layer and the carbon sheet, and a positive electrode active material layer. The negative electrode active material layer contains a negative electrode active material. The negative electrode active material contains a lithium metal. The thickness of the carbon sheet is greater than or equal to 25 nm and less than or equal to 50 μm. The dendrite has a portion along a plane of the carbon sheet.

In the present invention, the secondary battery preferably further include an electrolyte solution, and the electrolyte solution contains ethylene carbonate and diethyl carbonate.

In the present invention, the carbon sheet preferably includes carbon nanotubes.

According to one embodiment of the present invention, a highly reliable secondary battery in which an internal short circuit is prevented can be provided.

### BRIEF DESCRIPTION OF THE DRAWINGS

In the accompanying drawings:

FIGS. 1A and 1B illustrate a laminated secondary battery of one embodiment of the present invention, and FIG. 1C illustrates the flow of electrons and lithium ions in charging of the secondary battery;

FIG. 2A illustrates a negative electrode structure and a separator of one embodiment of the present invention, and FIGS. 2B to 2E are each an enlarged view of the negative electrode structure illustrating a growth direction of a dendrite;

FIGS. 3A to 3F are each an enlarged view of a negative electrode structure of one embodiment of the present invention illustrating a growth direction of a dendrite;

FIG. 4 shows a method for manufacturing a negative electrode structure of one embodiment of the present invention;

FIGS. 5A and 5B illustrate coating apparatuses of a negative electrode;

FIGS. 6A to 6D illustrate positive electrodes of one embodiment of the present invention;

FIGS. 7A to 7C illustrate a secondary battery of one embodiment of the present invention;

FIGS. 8A to 8D illustrate a secondary battery and a power storage system of one embodiment of the present invention;

FIGS. 9A to 9C illustrate a secondary battery of one embodiment of the present invention;

FIGS. 10A to 10C illustrate a secondary battery of one embodiment of the present invention;

FIGS. 11A to 11C illustrate an electric vehicle of one embodiment of the present invention;

FIGS. 12A to 12D illustrate transport vehicles of one embodiment of the present invention;

FIGS. 13A to 13C illustrate two-wheeled vehicles and the like of one embodiment of the present invention;

FIGS. 14A to 14D illustrate electronic devices and the like of one embodiment of the present invention; and

FIGS. 15A to 15D illustrate examples of a device for space.

### DETAILED DESCRIPTION OF THE INVENTION

Embodiments of the present invention will be described in detail with reference to the drawings as appropriate. However, the present invention is not limited to the description below, and it is easily understood by those skilled in the art that modes and details can be modified in various ways without departing from the spirit and scope of the present invention. Therefore, in the embodiments and examples of the present invention described below, reference numerals denoting the same portions are used in common in different drawings.

In this specification and the like, a full cell means a battery cell assembled such that different electrodes are positioned as in a unit cell of a positive electrode/a negative electrode. In this specification and the like, a half cell means a battery cell assembled using a lithium metal for a negative electrode (a counter electrode).

In this specification and the like, a loading level means the active material weight per unit area of a surface of a current collector. The loading level of a negative electrode active material can be adjusted in accordance with the capacity of a positive electrode. The above loading level is per side of a current collector in the case where a slurry containing an active material is applied onto both sides of the current collector.

In this specification and the like, slurry refers to a material solution that is used to form an active material layer over the current collector and contains an active material, a binder, and a solvent, preferably also contains a conductive material mixed therein. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

In this specification and the like, a median diameter (D50) is a particle diameter when accumulation of particles accounts for 50% of a cumulative curve in a measurement result of the particle size distribution. Note that there is a method for measuring a median diameter (D50) by image analysis with a SEM, a TEM, or the like. For example, the median diameter (D50) can be obtained by measuring 20 or more particles to make a particle size distribution curve, and setting a particle diameter when the accumulation of particle accounts for 50% as the median diameter (D50).

In this specification and the like, a lithium-ion secondary battery is sometimes called a lithium-ion battery and refers to as a battery in which lithium ions are used as carrier ions; however, carrier ions in the present invention are not limited to lithium ions. For example, as the carrier ion in the present invention, alkali metal ions or alkaline earth metal ions (specifically, sodium ions or the like) can be used. In that case, the present invention can be understood by replacing lithium ions with sodium ions or the like. In the case where a structure with no limitation on carrier ions is described, a simple term “secondary battery” is sometimes used.

In this specification and the like, a dendrite includes a tree-like crystal of a metal that grows in the charging and discharging process, and the dendrite includes a deposit of the metal. In the charging and discharging process, a thick region or a high-density region is formed in the dendrite. A plurality of dendrites may have different shapes, and one of the plurality of dendrites may have a larger thickness or a higher density than another one of the plurality of dendrites. Adjacent dendrites are tangled and aggregated in some cases.

In this specification and the like, a “carbonate” refers to a compound containing at least one ester in its molecular structure and includes a cyclic carbonate and a linear carbonate in its category unless otherwise specified. The term “linear” carbonate includes both “straight-chain” and “branched-chain” carbonate.

In this specification and the like, a low-temperature environment refers to an environment at a temperature lower than or equal to 0° C., and a temperature lower than or equal to 0° C. is sometimes referred to as “below freezing”.

In this specification and the like, unless otherwise specified, a charge voltage is shown with reference to the potential of a lithium metal. In this specification and the like, the “high charge voltage” is a charge voltage, for example, higher than or equal to 4.6 V, preferably higher than or equal to 4.65 V, further preferably higher than or equal to 4.7 V, still further preferably higher than or equal to 4.75 V, or most preferably higher than or equal to 4.8 V.

In this specification and the like, the expression “including A and/or B” means including A, including B, and including A and B.

### Embodiment 1

The secondary battery and the like of one embodiment of the present invention will be described.

### <Secondary Battery>

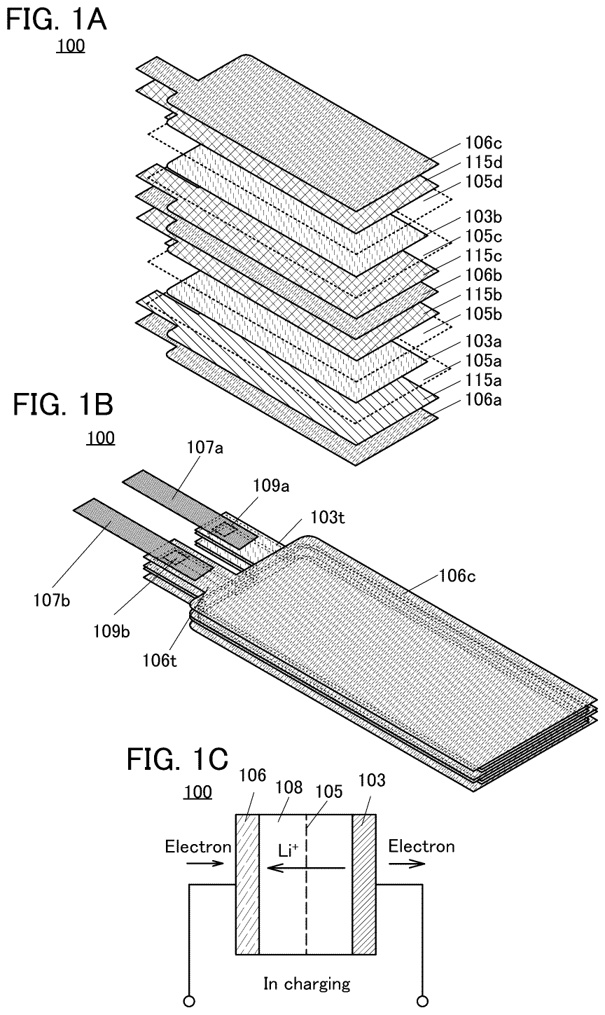

First, a secondary battery that is one embodiment of the present invention is described with reference to FIGS. 1A and 1B.

FIG. 1A illustrates a laminated secondary battery 100, and components of the secondary battery 100 are separated from each other for easy viewing in FIG. 1A. The secondary battery 100 includes a plurality of positive electrodes. As the plurality of positive electrodes, a first positive electrode 103a and a second positive electrode 103b are illustrated. Note that in the secondary battery 100, the number of positive electrodes is not limited and may be one. The first positive electrode 103a and the second positive electrode 103b are collectively referred to as a positive electrode 103.

The secondary battery 100 includes a plurality of negative electrodes. As the plurality of negative electrodes, a first negative electrode 106a, a second negative electrode 106b, and a third negative electrode 106c are illustrated. Note that in the secondary battery 100, the number of negative electrodes is not limited and may be one. The first negative electrode 106a, the second negative electrode 106b, and the third negative electrode 106c are collectively referred to as a negative electrode 106.

The secondary battery 100 includes separators between the negative electrodes and the positive electrodes. For easy viewing, separators are shown by dotted lines in FIG. 1A. As the separators, a first separator 105a, a second separator 105b, a third separator 105c, and a fourth separator 105d are illustrated in FIG. 1A. Note that in the secondary battery 100, the number of separators is not limited and may be one. Although the separator may be in an independent state as illustrated, a continuous separator can be used. By folding the continuous separator, the separator can be placed in positions corresponding to the first separator 105a to the fourth separator 105d.

The secondary battery 100 includes a first carbon sheet 115a between the first negative electrode 106a and the first separator 105a. A second carbon sheet 115b is included between the second separator 105b and the second negative electrode 106b. A third carbon sheet 115c is included between the second negative electrode 106b and the third separator 105c. A fourth carbon sheet 115d is positioned between the fourth separator 105d and the third negative electrode 106c. The first carbon sheet 115a, the second carbon sheet 115b, the third carbon sheet 115c, and the fourth carbon sheet 115d are collectively referred to as a carbon sheet 115. With the carbon sheet 115, an internal short circuit of the secondary battery 100 can be prevented, and the reliability of the secondary battery 100 can be improved.

FIG. 1B illustrates a state where components of the secondary battery 100 overlap with each other. The first positive electrode 103a and the second positive electrode 103b each include a positive electrode current collector and each positive electrode current collector includes a projecting portion 103t. The projecting portions 103t of the positive electrode current collectors overlap with each other to be an aggregate. The aggregate of the projecting portions 103t is referred to as a positive electrode tab. The first negative electrode 106a, the second negative electrode 106b, and the third negative electrode 106c each include a negative electrode current collector, and each negative electrode current collector includes a projecting portion 106t. The projecting portions 106t of the negative electrode current collectors overlap with each other to be an aggregate. The aggregate of the projecting portions 106t is referred to as a negative electrode tab.

The positive electrode further includes a positive electrode active material layer. The positive electrode active material layer is a layer including a positive electrode active material particle and includes a region in contact with the positive electrode current collector. A positive electrode manufacturing process involves pressing; in the positive electrode subjected to the pressing, a depressed portion in which the positive electrode active material particle is pressed into part of the positive electrode current collector is sometimes formed. The positive electrode active material layer is preferably formed on both sides of the positive electrode current collector. Such a structure is referred to as a double-side coating structure. The positive electrode active material layer may be formed only on one side of the positive electrode current collector. Such a structure is referred to as a single-side coating structure.

The negative electrode further includes a negative electrode active material layer. The negative electrode active material layer is a layer including a negative electrode active material particle and includes a region in contact with the negative electrode current collector. A negative electrode manufacturing process involves pressing; in the negative electrode subjected to this pressing, a depressed portion in which the negative electrode active material particle is pressed into part of the negative electrode current collector is sometimes formed. A double-side coating structure in which the negative electrode active material layer is formed on both sides of the negative electrode current collector can be employed. Note that for the negative electrode placed as the outermost layer, a single-side coating structure in which the negative electrode active material layer is formed on only one side of the negative electrode current collector is preferably used. In the negative electrode provided in the outermost layer, carrier ions are not inserted or extracted or are unlikely to be inserted or extracted from the negative electrode active material layer that does not face the positive electrode. Thus, this negative electrode active material layer is not necessarily formed. It is preferable that all the negative electrodes have a double-side coating structure because the productivity is high; thus, the negative electrode with a double-side coating structure may be provided in the outermost layer.

In the case where the secondary battery 100 is used while being bent, a negative electrode with a single-side coating structure is preferably prepared. A structure in which a plurality of negative electrodes with a single-side coating structure are stacked such that negative electrode current collectors are in contact with each other is referred to as a back-to-back structure. With the back-to-back structure, the secondary battery 100 is easily bent because the negative electrode current collectors with low contact resistance are in contact with each other.

As illustrated in FIG. 1B, a plurality of positive electrodes, a plurality of negative electrodes, and a plurality of separators are collectively referred to as a stacked electrode. In the stacked electrode, the positive electrode tab (the projecting portions 103t) is bonded to a positive electrode lead 107a at a bonding portion 109a. In the stacked electrode, the negative electrode tab (the projecting portions 106t) is bonded to a negative electrode lead 107b at a bonding portion 109b. Bonding at the bonding portion can be performed using ultrasonic bonding. As a result of the bonding, the components are electrically connected to each other. The positive electrode lead 107a can be formed using a material selected from aluminum, nickel, titanium, and an alloy thereof. The negative electrode lead 107b can be formed using a material selected from nickel, copper, titanium, and an alloy thereof.

The secondary battery 100 further includes an exterior body (not illustrated). The stacked electrode shown in FIG. 1B is held in the exterior body. As the exterior body, a film is preferably used in terms of weight reduction. A secondary battery using a film as its exterior body is referred to as a laminated secondary battery. Although not illustrated in this embodiment, a can case may be used as the exterior body; in the case where a circular can case is used, the secondary battery is referred to as a coin-type secondary battery.

Here, the flow of electrons and the flow of lithium ions (Li⁺ in the drawing) in charging the secondary battery 100 are described with reference to FIG. 1C. Two terminals in FIG. 1C are connected to a charger, and the secondary battery 100 is charged. In charging, electrons are released from the positive electrode 103, so that an oxidation reaction occurs. At this time, lithium ions (Li⁺) are released into an electrolyte solution 108 from the positive electrode. In charging, electrons are supplied to the negative electrode 106, so that a reduction reaction occurs. At this time, lithium ions in the electrolyte solution 108 transfer to the negative electrode 106. In the case where graphite is used as the negative electrode active material, transferred lithium is inserted between graphite layers. The potential of the negative electrode in a state where lithium is inserted between graphite layers is substantially equal to that of the case where a lithium metal is used as the negative electrode active material. In the case where silicon or an alloy thereof is used as the negative electrode active material, the potential is substantially equal to that of the case where a lithium metal is used as the negative electrode active material. The lithium metal is deposited when charging at high rate or at a low temperature is performed in the state with this potential. Note that when the secondary battery 100 is regarded as a closed circuit, current flows in the same direction as the movement of lithium ions. Although not illustrated, in discharging, the negative electrode 106 releases electrons and the lithium metal is dissolved in the electrolyte solution 108. When charging and discharging are repeated, the lithium metal deposition and dissolution are repeated on and from the negative electrode. When such a phenomenon is repeated, attachment of decomposition products of the electrolyte solution, omission of an electron conduction path, or the like might make the surface of the negative electrode 106 uneven, the lithium metal becomes a dendrite, and the growth of the dendrite proceeds.

Note that in the secondary battery, an anode and a cathode change places in discharging and charging, and an oxidation reaction and a reduction reaction occur on the corresponding sides; hence, an electrode with a high reaction potential is called a positive electrode and an electrode with a low reaction potential is called a negative electrode. For this reason, in this specification and the like, the positive electrode is referred to as a “positive electrode” or a “plus electrode” and the negative electrode is referred to as a “negative electrode” or a “minus electrode” in all the cases where charge is performed and discharge is performed.

Next, the negative electrode and the carbon sheet of one embodiment of the present invention are described.

### Structure Example 1

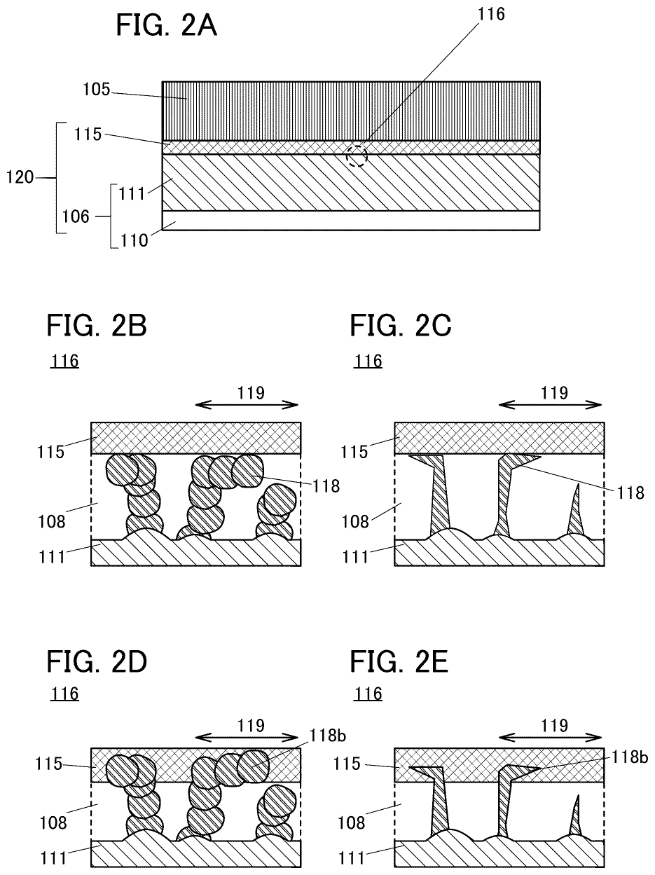

FIG. 2A illustrates the negative electrode 106, the carbon sheet 115, and a separator 105 included in the secondary battery 100. The negative electrode 106 and the carbon sheet 115 are collectively referred to as a negative electrode structure 120. The carbon sheet 115 is placed between the negative electrode 106 and the separator 105 to overlap with the negative electrode 106. Specifically, the carbon sheet 115 is preferably provided to overlap with a negative electrode current collector 110 described later, and the carbon sheet 115 preferably extends to a position overlapping with the negative electrode tab (the projecting portion 106t). In the negative electrode tab, the negative electrode current collector 110 and the carbon sheet 115 have the same potential. As another embodiment, the carbon sheet 115 is provided to overlap with a negative electrode active material layer 111 described later. In order to control the growth direction of a dendrite described later, it is important that the carbon sheet 115 overlaps with the negative electrode active material layer 111.

### <Negative Electrode 106>

The negative electrode 106 includes the negative electrode current collector 110 and the negative electrode active material layer 111. The negative electrode active material layer 111 is a layer including a negative electrode active material particle, and may further include a binder. The negative electrode active material layer 111 may further include a conductive material. Needless to say, the negative electrode active material layer 111 does not necessarily include a binder or a conductive material. The binder and the conductive material will be described later.

### <Carbon Sheet 115>

The carbon sheet 115 includes carbon and preferably includes, for example, carbon fiber (also referred to as CF), typically a carbon nanotube (referred to as CNT). CNT is a substance made of carbon; specifically, CNT has a structure where a sheet in which carbon atoms forming hexagons are arranged in a planar shape is cylindrically rounded. The diameter of the rounded structure can be greater than or equal to 10 nm and less than or equal to 25 nm. CNT can be formed by an arc discharge method, a laser evaporation method (a laser ablation method), or a chemical vapor deposition method (a CVD method). CNT is chemically stable and thermally stable. Furthermore, CNT has high conductivity like a metal. Thus, CNT is suitable for the carbon sheet 115, and a carbon sheet including CNT is referred to as a CNT sheet.

One example of CNT is a single-walled CNT, which has a single-layer cylindrical structure. The single-walled CNT is likely to be long and flexible. Another example of CNT is a multi-walled CNT, which has a structure where a first cylindrical structure having a first diameter is provided inside a second cylindrical structure having a second diameter larger than the first diameter. The multi-walled CNT may have three or more cylindrical structures. The multi-walled CNT is likely to be short and hard. As the carbon sheet 115, the single-walled CNT and/or the multi-walled CNT can be used. As the carbon sheet, a stack of the single-walled CNTs or a stack of the multi-walled CNTs can be used.

In the CNT sheet, directions of major axes (major-axis directions) of CNTs can be aligned. In other words, in the CNT sheet, the major axes of CNTs can be aligned in one direction or substantially one direction. A group of CNTs whose major axes are aligned in one direction or substantially one direction is referred to as a bundle of CNTs in some cases. A sheet including the group of CNTs whose major axes are aligned in one direction or substantially one direction is referred to as an unidirectionally aligned CNT sheet in some cases. The unidirectionally aligned CNT sheet has high tensile strength in the major axis direction and is suitable for the carbon sheet 115.

Although the carbon sheet 115 is illustrated as a single layer, the carbon sheet 115 may be a stack of a plurality of carbon sheets (a stacked-layer structure). The stacked-layer structure can make the thickness of the carbon sheet 115 appropriate. In the case where a plurality of CNT sheets are stacked, the CNT sheets are preferably stacked such that the major axes intersect with each other. The plurality of CNT sheets in which the major axes intersect with each other are suitable for the carbon sheet 115. In stacking, the CNTs at the interface can be aggregated by spraying an organic solvent. In other words, an independent CNT sheet can be obtained without a binder.

The carbon sheet 115 may include a vapor-grown carbon fiber (VGCF: registered trademark). VGCF (registered trademark) is suitable for the carbon sheet 115 because it can have a diameter of greater than or equal to 90 nm and less than or equal to 200 nm, preferably greater than or equal to 90 nm and less than or equal to 110 nm and a fiber length of greater than or equal to 7 μm and less than or equal to 15 μm.

The carbon sheet 115 may contain graphene. A carbon sheet containing graphene is referred to as a graphene sheet. In this specification and the like, graphene contains carbon, has a plate-like shape, a sheet-like shape, or the like, and has a two-dimensional structure formed of six-membered rings composed of carbon atoms. Graphene may partly have a defect; in this case, a poly-membered ring such as a seven-membered ring, an eight-membered ring, a nine-membered ring, or a ten-membered ring is formed in graphene. Note that the poly-membered ring refers to a ring-shaped carbon skeleton in which a carbon bond in part of a six-membered ring composed of carbon atoms is broken and the broken carbon bond is bonded to another broken carbon bond. A region surrounded with carbon atoms in the poly-membered ring is a gap. In this specification and the like, graphene includes a multilayer graphene. Graphene is suitable for the carbon sheet 115 because of its excellent electrical characteristics of high conductivity.

The carbon sheet 115 may contain a graphene compound. A carbon sheet containing a graphene compound is referred to as a graphene compound sheet. In this specification and the like, a graphene compound includes graphene oxide, multilayer graphene oxide, reduced graphene oxide, reduced multilayer graphene oxide, and the like. In other words, a graphene compound may include a functional group, and examples of the functional group include an epoxy group, a carboxy group, and a hydroxy group. A graphene compound is suitable for the carbon sheet 115 because of its high flexibility and excellent electrical characteristics of high conductivity. A graphene compound is suitable for the carbon sheet 115 because of having a defect or a space that lithium ions can pass through.

In this specification and the like, reduced graphene oxide contains carbon and oxygen and has a two-dimensional structure formed of a six-membered ring composed of carbon atoms. The reduced graphene oxide preferably includes a portion where the carbon concentration is higher than 80 atomic % and the oxygen concentration is higher than or equal to 2 atomic % and lower than or equal to 15 atomic %.

The carbon sheet 115 may include a binder to increase adhesion to the negative electrode 106.

In the case where the negative electrode structure 120 is used for the negative electrode with a double-side coating structure like the second negative electrode 106b illustrated in FIGS. 1A to 1C, two carbon sheets 115 are prepared for the second negative electrode 106b. That is, the carbon sheets 115 are provided between the second negative electrode 106b and the third separator 105c, and between the second negative electrode 106b and the second separator 105b.

FIG. 2B is an enlarged view corresponding to a region 116 surrounded by a dashed line in FIG. 2A. As illustrated in FIG. 2B, unevenness is observed on the surface or the top surface of the negative electrode active material layer 111. This unevenness reflects the shape of the negative electrode active material particle. Furthermore, a region between the carbon sheet 115 and the negative electrode active material layer 111 that are apart or separated from each other is impregnated with the electrolyte solution 108. When a repetitive charge and discharge cycle test is performed, current might be concentrated on unevenness. Then, lithium is unevenly deposited from the negative electrode active material layer 111, so that a dendrite 118 is likely to be formed. Furthermore, the dendrite 118 grows by performing the repetitive charge and discharge cycle test.

In one embodiment of the present invention, the carbon sheet 115 is provided as illustrated in FIG. 2B; thus, the dendrite 118 grows along the carbon sheet 115. In the case where a surface of the carbon sheet 115 is observed, it can be said that the dendrite 118 has a portion along the surface of the carbon sheet 115. An arrow 119 is added as an example of the growth direction of the dendrite 118. The direction of the arrow 119 can be regarded as a direction intersecting with the normal direction of the secondary battery when the normal direction of the secondary battery is defined as penetrating the positive electrode and the negative electrode. In the case where the normal direction is “vertical”, the direction of the arrow 119 can be regarded as “horizontal”. The direction of the arrow 119 can be regarded as a direction along the major axes of CNTs in the case where the CNT sheet is used as the carbon sheet 115. The direction of the arrow 119 may be referred to as a direction along the negative electrode. Note that the growth direction of the dendrite 118 may vary depending on the dendrite. That is, the growth direction of the dendrite 118 is aligned or substantially aligned with the arrow 119; to be more specific, the dendrite 118 is prevented from reaching the positive electrode.

The reason why the dendrite 118 grows in such a direction is probably because the dendrite 118 grows while receiving electrons from the carbon sheet 115 in the reduction reaction. Since the carbon sheet 115 has high conductivity, the carbon sheet 115 reacts with the electrolyte solution 108 actively in the reduction reaction. Furthermore, the carbon sheet 115 is preferably set to have the same potential as the negative electrode 106 in the reduction reaction. That is, the carbon sheet 115 and the negative electrode current collector 110 are preferably in contact with each other in the negative electrode tab. Then, the dendrite 118 can grow along the carbon sheet 115 after reaching the carbon sheet 115. As described above, the growth direction of the dendrite 118 varies depending on the dendrite. Such a phenomenon prevents the dendrite 118 from reaching the positive electrode. Thus, the structure in which the carbon sheet 115 is provided as illustrated in FIG. 2B reduces the internal short circuit of the secondary battery 100. FIG. 2C illustrates a structure in which the dendrite 118 in FIG. 2B has a needle-like shape.

### Application Example 1

As illustrated in FIG. 2D, a dendrite 118b may reach the inside of the carbon sheet 115. In other words, the dendrite 118b grows in the direction of the arrow 119 inside the carbon sheet 115 in some cases. Such a phenomenon prevents the dendrite 118b from reaching the positive electrode. Thus, the structure in which the carbon sheet 115 is provided as illustrated in FIG. 2D reduces the internal short circuit of the secondary battery 100. FIG. 2E illustrates a structure in which the dendrite 118b in FIG. 2D has a needle-like shape.

### Application Example 2

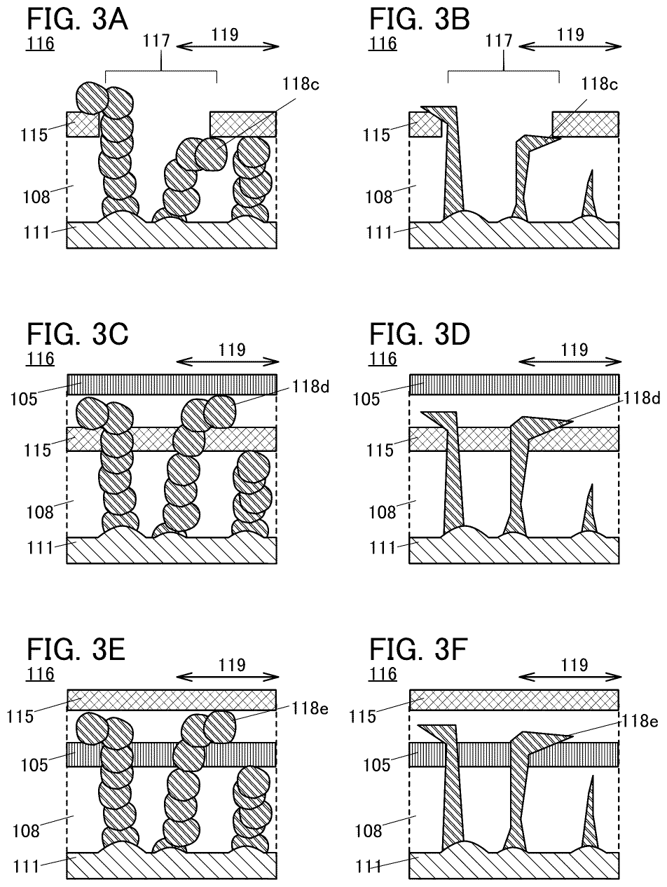

As illustrated in FIG. 3A, the carbon sheet 115 may be divided unless a dendrite 118c reaches the positive electrode. “The carbon sheet 115 is divided” indicates that a divided region is observed in the carbon sheet 115 in the top view. The divided region is observed as a gap 117 in the cross-sectional view of the above carbon sheet 115. Lithium ions can enter and leave through the gap 117. The dendrite 118c may grow in the direction of the arrow 119 without passing through the gap 117. Furthermore, the dendrite 118c may grow in the direction of the arrow 119 after passing through the gap 117. Such a phenomenon prevents the dendrite 118c from reaching the positive electrode. Thus, the structure in which the carbon sheet 115 is provided as illustrated in FIG. 3A reduces the internal short circuit of the secondary battery 100. FIG. 3B illustrates a structure in which the dendrite 118c in FIG. 3A has a needle-like shape.

### Application Example 3

As illustrated in FIG. 3C, a dendrite 118d may penetrate the carbon sheet 115 unless it reaches the positive electrode. In this example, there is no divided region in the carbon sheet 115. Furthermore, the dendrite 118d may exist between the separator 105 and the carbon sheet 115 and may grow in the arrow 119 direction therebetween. Note that the dendrite 118d does not penetrate the separator 105. Such a phenomenon prevents the dendrite 118d from reaching the positive electrode. Thus, the structure in which the carbon sheet 115 is provided as illustrated in FIG. 3C reduces the internal short circuit of the secondary battery 100. FIG. 3D illustrates a structure in which the dendrite 118d in FIG. 3C has a needle-like shape.

### Application Example 4

As illustrated in FIG. 3E, the carbon sheet 115 may be positioned between the separator 105 and the positive electrode. A dendrite 118e may penetrate the separator 105. Furthermore, the dendrite 118e may exist between the carbon sheet 115 and the separator 105 and may grow in the arrow 119 direction. Note that the dendrite 118e does not penetrate the carbon sheet 115. Such a phenomenon prevents the dendrite 118e from reaching the positive electrode. Thus, the internal short circuit of the secondary battery 100 is reduced. FIG. 3F illustrates a structure in which the dendrite 118e in FIG. 3E has a needle-like shape.

### Application Example 5

Although not illustrated, the carbon sheet 115 may be tangled with the dendrite 118. In other words, the carbon sheet 115 and the dendrite 118 may become a single component, and the dendrite 118 and the like may be observed inside and outside the carbon sheet 115. Such a phenomenon prevents the dendrite 118 from reaching the positive electrode. Thus, the internal short circuit of the secondary battery 100 is reduced.

Based on the above application example 5, the growth direction of the dendrite 118 is not necessarily aligned with the arrow 119 direction. That is, in one embodiment of the present invention, the growth direction of the dendrite 118 is not important as long as the carbon sheet 115 can prevent the dendrite 118 from reaching the positive electrode.

In the structures illustrated in FIGS. 2B to 3F, the thickness of the carbon sheet 115 is greater than or equal to 25 nm, preferably greater than or equal to 25 nm and less than or equal to 50 μm, greater than or equal to 25 nm and less than or equal to 10 μm, greater than or equal to 25 nm and less than or equal to 1 μm, or greater than or equal to 25 nm and less than or equal to 500 nm. To obtain the above thickness, the carbon sheet 115 is stacked in some cases. The thickness of the above carbon sheet 115 may be greater than or equal to 0.5 times and less than or equal to 1.5 times the thickness of the separator.

With the above-described structure and the like, the dendrite does not reach the positive electrode and the internal short circuit of the secondary battery can be prevented.

### Example 1 of Manufacturing Method

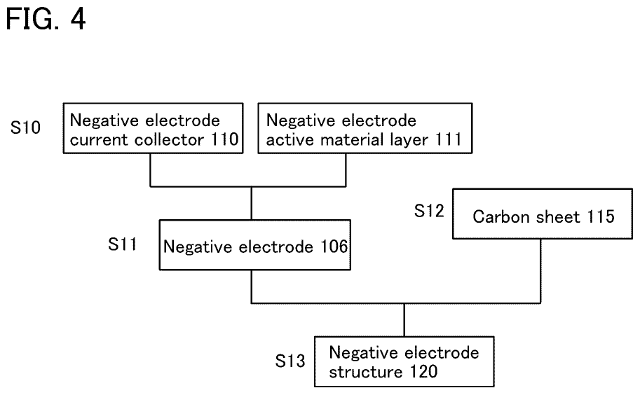

An example of a method for manufacturing the above-described negative electrode structure 120 will be described with reference to FIG. 4.

### <Step S10>

In Step S10 shown in FIG. 4, the negative electrode current collector 110 and the negative electrode active material layer 111 are prepared.

### <Negative Electrode Current Collector 110>

The negative electrode current collector 110 is described. The negative electrode current collector can be formed using a material that has high conductivity, such as a metal like copper, stainless steel, gold, platinum, or titanium, or an alloy thereof. It is also possible to use an aluminum alloy to which an element that improves heat resistance, such as silicon, titanium, neodymium, scandium, or molybdenum, is added for the negative electrode current collector. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The negative electrode current collector can have a foil-like shape, a plate-like shape, a sheet-like shape, a net-like shape, a punching-metal shape, an expanded-metal shape, or the like as appropriate. The negative electrode current collector preferably has a thickness greater than or equal to 5 μm and less than or equal to 30 μm.

### <Negative Electrode Active Material>

A negative electrode active material included in the negative electrode active material layer 111 is described. For the negative electrode active material, a material capable of occluding and releasing lithium can be used. For the negative electrode active material, a material that enables charge and discharge reactions by an alloying reaction and a dealloying reaction with lithium can be used. For the negative electrode active material, one or more composite materials selected from a lithium metal, carbon, and silicon can be used, for example. Silicon is preferably used because of its high theoretical capacity of 4200 mAh/g per weight of the active material. In the case where a lithium metal is used as the negative electrode active material, the negative electrode current collector can be omitted.

Examples of carbon include graphite, graphitizing carbon (soft carbon), non-graphitizing carbon (hard carbon), CNT, graphene, and carbon black. That is, in the case where the multi-walled CNT is used for the carbon sheet 115 or the case where the multilayer graphene is used for the carbon sheet 115, lithium can be occluded and released by the carbon sheet 115.

Graphite has a low potential substantially equal to that of a lithium metal (greater than or equal to 0.05 V and less than or equal to 0.3 V vs. Li/Li⁺) when lithium ions are inserted into the graphite (while a lithium-graphite intercalation compound is formed). For this reason, a secondary battery can have a high operating voltage. In addition, graphite is preferable because of its advantages such as a relatively high charge and discharge capacity per unit volume, relatively small volume expansion, low cost, and a higher level of safety than that of a lithium metal.

The negative electrode active material with a small median diameter (D50) may become bulky, hindering an increase in electrode density. Thus, the median diameter (D50) of the negative electrode active material preferably satisfies the range of greater than or equal to 3 μm and less than or equal to 20 μm, further preferably greater than or equal to 7 μm and less than or equal to 12 μm. Graphite is a typical example of the negative electrode active material satisfying the above range, and the median diameter (D50) of graphite preferably satisfies the above range as a powder characteristic.

Examples of graphite include artificial graphite and natural graphite. Examples of artificial graphite include mesocarbon microbeads (MCMB), coke-based artificial graphite, and pitch-based artificial graphite. Artificial graphite may have a carbon coat layer that is a low crystalline layer. Since artificial graphite has a spherical shape, the artificial graphite is referred to as spherical graphite. For example, MCMB is one of preferable materials as spherical graphite. Moreover, MCMB can relatively easily have a small specific surface area. In the case where the specific surface area is large, the decomposition reaction with the electrolyte solution occurs significantly on the surface of the negative electrode active material; thus, favorable cycle characteristics cannot be obtained in some cases. In order to inhibit the above decomposition reaction, the specific surface area of carbon preferably satisfies greater than or equal to 0.8 m²/g and less than or equal to 8 m²/g, further preferably greater than or equal to 1 m²/g and less than or equal to 2 m²/g. Typically, spherical graphite preferably has the above-described specific surface area as a powder characteristic. The specific surface area can be measured by a Brunauer-Emmett-Teller (BET) method. The BET method is an analytical method in which Langmuir's theory of adsorption is extended to multilayer adsorption of adsorbed gas molecules, which is the most common method for calculating the specific surface area. For measuring the specific surface area by the BET method, an automated specific surface area analyzer TriStar II 3020 can be used.

Examples of natural graphite include flake graphite and spherical natural graphite. Natural graphite may include a carbon coat layer that is a low crystalline layer.

Alternatively, a silicon-carbon composite material containing carbon and silicon can be used as the negative electrode active material. In the silicon-carbon composite material, it is preferable that carbon and silicon be a mixture and the sintered state through heat treatment be observed. In the silicon-carbon composite material, a graphite particle is preferably used for carbon, and the median diameter (D50) of the graphite particle is greater than or equal to 1 μm and less than or equal to 20 μm, preferably greater than or equal to 3 μm and less than or equal to 20 μm, further preferably greater than or equal to 7 μm and less than or equal to 12 μm. The median diameter of the graphite particle can be determined in consideration of the median diameter (D50) of silicon.

The specific surface area of the graphite particle is preferably greater than or equal to 0.5 m²/g and less than or equal to 3 m²/g. The specific surface area can be measured by the BET method. The specific surface area by the BET method is a value measured by a nitrogen gas adsorption one-point BET method, and a micromeritics automatic surface area and porosity analyzer Tristar II 3020 (produced by SHIMADZU CORPORATION) can be used as a measuring instrument.

In the silicon-carbon composite material, silicon particles are preferably used for silicon. The silicon particle contains a silicon material, specifically, preferably one selected from silicon, silicon oxide, and a silicon alloy. Examples of silicon oxide include silicon monoxide (SiO). In this specification and the like, SiO refers, for example, to silicon monoxide. Silicon monoxide can also be expressed as SiOₓ. It is preferable that x be greater than or equal to 0.2 and less than or equal to 1.5, further preferably greater than or equal to 0.3 and less than or equal to 1.2.

The median diameter (D50) of the silicon particle is preferably less than 1 μm, typically greater than or equal to 50 nm and less than or equal to 800 nm, further preferably greater than or equal to 100 nm and less than or equal to 500 nm. A silicon particle with such a size is referred to as a nanosilicon particle in some cases. Although silicon has a problem of expansion and contraction at the time of charging and discharging, a nanosilicon particle that is miniaturized to have the above median diameter (D50) is suitable for reducing charge and discharge deterioration. The silicon particle preferably has a uniform median diameter (D50) through a grinding step of the silicon raw material.

The specific surface area of the silicon particle is preferably greater than or equal to 10 m²/g and less than or equal to 35 m²/g, further preferably greater than or equal to 10 m²/g and less than or equal to 15 m²/g. The specific surface area can be measured by the BET method. The specific surface area by the BET method is a value measured by a nitrogen gas adsorption one-point BET method, and a micromeritics automatic surface area and porosity analyzer Tristar II 3020 (produced by SHIMADZU CORPORATION) can be used as a measuring instrument.

With the structure in which the negative electrode active material contains both graphite particles and silicon particles, a secondary battery with high discharge capacity can be achieved.

Moreover, the median diameter (D50) of the graphite particle is larger than the median diameter (D50) of the silicon particle; when these particles are mixed and used for the negative electrode, a loading level of the negative electrode active material can be increased. The output characteristics of a lithium-ion secondary battery can be increased with a small loading level, but can be decreased with a high loading level. Thus, the loading level of the negative electrode active material is preferably higher than or equal to 3 mg/cm² and lower than or equal to 10 mg/cm².

In the negative electrode active material layer 111, the weight of the graphite particle is preferably greater than that of the silicon particle; typically, the weight proportion of the graphite particle is preferably greater than or equal to 5 times and less than or equal to 35 times that of the silicon particle. In other words, the silicon weight proportion in the total weight of the powder materials forming the negative electrode active material is greater than or equal to 2 wt % and less than or equal to 37.5 wt %.

As the negative electrode active material, for example, a material containing one or more selected from tin, gallium, aluminum, germanium, lead, antimony, bismuth, silver, zinc, cadmium, indium, and the like can be used.

As the negative electrode active material, a compound containing one or more selected from tin, gallium, aluminum, germanium, lead, antimony, bismuth, silver, zinc, cadmium, indium, and the like can also be used. A compound containing two or more of these elements can be referred to as an alloy material, and for example, magnesium silicide (Mg₂Si) can be given.

Other examples of the alloy material include a magnesium-germanium alloy (Mg₂Ge), tin (II) oxide (SnO), tin (IV) oxide (SnO₂), a magnesium-tin compound (Mg₂Sn), tin (IV) sulfide (SnS₂), other main binary alloys of tin (V₂Sn₃, FeSn₂, CoSn₂, Ni₃Sn₂, Cu₆Sns, Ag₃Sn, LaSn₃, La₃Co₂Sn₇, and SbSn), and binary alloys of antimony (Ag₃Sb, Ni₂MnSb, CeSb₃, CoSb₃, and InSb).

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Still alternatively, as the negative electrode active material, Li₃₋ₓMₓN (M=Co, Ni, or Cu) with a Li₃N structure, which is a nitride containing lithium and a transition metal, can be used. For example, Li_{2.6}Co_{0.4}N is preferable because of its high discharge capacity (900 mAh/g per weight of the active material and 1890 mAh/cm³).

A nitride containing lithium and a transition metal is preferably used, in which case lithium ions are contained in the negative electrode active material and thus the negative electrode active material can be used in combination with a material for the positive electrode active material which does not contain lithium ions, such as V₂O₅ or Cr₃O₈. Note that in the case of using a material containing lithium ions as the positive electrode active material, the nitride containing lithium and a transition metal can be used as the negative electrode active material by extracting the lithium ions contained in the positive electrode active material in advance.

As another mode of the negative electrode, a negative electrode that does not contain a negative electrode active material after completion of the fabrication of the battery may be used. As the negative electrode that does not contain a negative electrode active material, for example, a negative electrode can be used in which only a negative electrode current collector is included after completion of the fabrication of the battery and in which lithium ions extracted from the positive electrode active material due to charge of the battery are deposited as a lithium metal on the negative electrode current collector and form the negative electrode active material layer. A battery including such a negative electrode is referred to as a negative electrode-free (anode-free) battery, a negative electrodeless (anodeless) battery, or the like in some cases.

When the negative electrode that does not contain a negative electrode active material is used, a film may be included over the negative electrode current collector for uniforming lithium deposition. For the film for uniforming lithium deposition, for example, a solid electrolyte having lithium ion conductivity can be used. As the solid electrolyte, a sulfide-based solid electrolyte, an oxide-based solid electrolyte, a polymer-based solid electrolyte, or the like can be used. In particular, the polymer-based solid electrolyte can be uniformly formed as a film over a negative electrode current collector relatively easily, and thus is preferable as the film for uniforming lithium deposition. Moreover, as the film for uniforming lithium deposition, for example, a metal film that forms an alloy with lithium can be used. As the metal film that forms an alloy with lithium, for example, a magnesium metal film can be used. It is suitable for the film for making lithium deposition uniform because lithium and magnesium form a solid solution in a wide range of compositions.

When the negative electrode that does not contain a negative electrode active material is used, a negative electrode current collector having unevenness can be used. When the negative electrode current collector having unevenness is used, a depression of the negative electrode current collector becomes a cavity in which lithium contained in the negative electrode current collector is easily deposited, so that the lithium can be prevented from having a dendrite-like shape when being deposited.

### <Binder>

The negative electrode active material layer 111 preferably includes a binder. As the binder, a polymer including a carboxy group is preferably used. It can be said that the carboxy group includes two basic oxygen atoms, one acidic hydrogen atom, and one electrophilic carbon atom. It can also be said that the carboxy group includes OH, which is a hydroxy group, and C═O, which is a carbonyl group, and is a group having a polarity. When the binder includes a group having a polarity, such as a carboxy group, interaction with a lithium ion draws lithium ions; thus, insertion of lithium ions into the negative electrode active material might be aided. Note that the carboxy group can be identified by Fourier transform infrared spectroscopy (FT-IR) or the like.

Examples of a polymer including a carboxy group include polyglutamic acid (sometimes referred to as PGA), polyacrylic acid (sometimes referred to as PAA), and alginic acid (sometimes referred to as polysaccharide). Alternatively, polyamino acid may be used as the polymer including a carboxy group; specifically, polyornithine or polysarcosine may be used for the binder. Furthermore, as a polymer including a carbonyl group, polyaspartic acid may be used for the binder. Alternatively, a binary copolymer (copolymer) may be used as the polymer including a ketone group; a copolymer of acrylic acid and maleic acid or a copolymer of acrylic acid and sulfonic acid may be used for the binder. Use of such materials for a binder of a negative electrode also brings an effect of reducing the amount of the binder mixed in the negative electrode.

Among the above-described polymers, polyglutamic acid or polyacrylic acid is particularly preferable as the binder used for the negative electrode. Structural Formula (H2) below is a structural formula of polyglutamic acid.

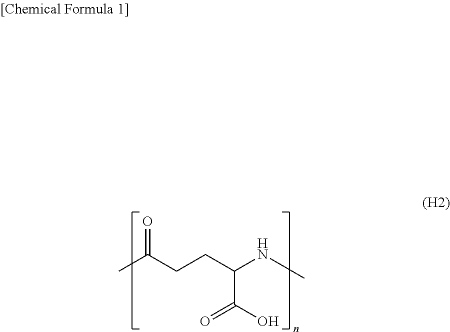

Polyglutamic acid contains nitrogen in addition to the carboxy group as shown in Structural Formula (H2). The nitrogen includes an unshared electron pair and thus is expected to interact with a lithium ion. For example, the unshared electron pair possibly draws lithium ions to aid insertion of lithium ions into the negative electrode active material.

As is apparent from the structural formula, polyglutamic acid includes C═O, which is a carbonyl group. When the binder includes a group having a polarity, such as a carbonyl group, interaction with a lithium ion serving as a carrier ion is expected, and insertion and extraction of lithium ions in the negative electrode active material might be aided.

As polyglutamic acid, either straight-chain γ-polyglutamic acid or cross-linked γ-polyglutamic acid may be used for the binder, and these acids are collectively referred to as a structure including γ-polyglutamic acid as a main component. Note that the cross-linked γ-polyglutamic acid is more suitable for the binder because it has a net-like structure. Furthermore, the molecular weight of polyglutamic acid is preferably greater than or equal to 1 million, further preferably greater than or equal to 3 million, still further preferably greater than or equal to 10 million and less than or equal to 50 million.

Depending on the formation method, polyglutamic acid can be referred to as γ-polyglutamic acid containing another element (e.g., Ca, Al, Na, Mg, Fe, Si, or S) as a main component. That is, polyglutamic acid may be neutralized with an alkali metal ion, for example, a lithium ion or a sodium ion.

Such polyglutamic acid has hydrophilicity and thus deionized water can be used as the solvent, which is suitable for formation of a slurry. Moreover, polyglutamic acid can provide a secondary battery with favorable low-temperature characteristics.

Structural Formula (H1) below is a structural formula of polyacrylic acid.

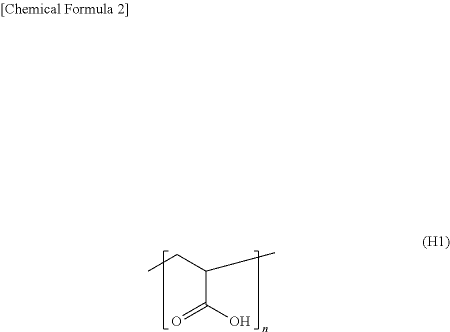

As is apparent from the structural formula (H1), polyacrylic acid includes a carboxy group.

A material in which polyacrylic acid is cross-linked may be used. A cross-link structure, i.e., a net-like structure, can be formed, which is preferable because the function of the binder can be enhanced. Moreover, polyacrylic acid can provide a secondary battery with favorable low-temperature characteristics.

As the binder except the above, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Alternatively, fluororubber can be used as the binder.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

### <Thickener>

In addition to the binder, a thickener is preferably used. For the thickener, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used.

### <Conductive Material>

The negative electrode active material layer 111 may include a conductive material. The conductive material has a function of giving aid to, for example, a current path between the active material and the current collector or a current path between a plurality of the active materials. In order to have such a function, the conductive material preferably includes a material having lower resistance than the active material. The conductive material is also referred to as a conductive additive or a conductivity-imparting agent because of its function. A conductive material is attached between a plurality of active materials, whereby the plurality of active materials are electrically connected to each other, and the conductivity increases. Note that the term “attach” in this specification and the like refers not only to a state where an active material and a conductive material are physically in close contact with each other, and includes, for example, the following: a case where covalent bonding occurs, a case where bonding with the Van der Waals force occurs, a case where a conductive material covers part of the surface of an active material, a case where a conductive material is embedded in surface roughness of an active material, and a case where an active material and a conductive material are electrically connected to each other without being in contact with each other.

As the conductive material, a carbon material or a metal material is typically used. The conductive material is in a particulate form; examples of the particulate conductive material include carbon black (e.g., furnace black, acetylene black, or graphite). Some conductive materials are in a fibrous form; examples of the fibrous conductive material include CNT and VGCF (registered trademark). Other conductive materials are in a sheet form; examples of the sheet-shaped conductive material include multilayer graphene. The sheet-shaped conductive material sometimes looks like a thread in observation of a cross section of a positive electrode.

The particulate conductive material can enter a gap between, for example, negative electrode active materials, and easily aggregates. Thus, the particulate conductive material can give aid to a conductive path between negative electrode active materials provided close to each other. Although having a bent region, the fibrous conductive material is larger than a negative electrode active material. The fibrous conductive material can thus give aid to not only a conductive path between adjacent negative electrode active materials but also a conductive path between negative electrode active materials that are apart from each other. Conductive materials in two or more forms as described above are preferably mixed.

In the case where multilayer graphene as a sheet-shaped conductive material and carbon black as a particulate conductive material are used, the weight of the carbon black is preferably greater than or equal to 1.5 times and less than or equal to 20 times, further preferably greater than or equal to twice and less than or equal to 9.5 times that of the multilayer graphene in a slurry in which the carbon black and the multilayer graphene are mixed.

When the mixing ratio between the multilayer graphene and the carbon black is in the above range, the carbon black does not aggregate and is easily dispersed. When the mixing ratio between the multilayer graphene and the carbon black is in the above range, the electrode density can be higher than when only the carbon black is used as a conductive material. A higher electrode density leads to higher capacity per unit weight.

Moreover, when the mixing ratio between the multilayer graphene and the carbon black is in the above range, rapid charging is possible.

A graphene compound may be used instead of the above-described multilayer graphene as the conductive material. As a graphene compound, fluorine-containing graphene may be used. Fluorine in the graphene compound is preferably adsorbed on the surface. Fluorine-containing graphene can be formed by making graphene and a fluorine compound contact each other (which is called fluorination treatment). The fluoridation treatment is preferably performed using fluorine (F₂) or a fluorine compound. The fluorine compound is preferably hydrogen fluoride, halogen fluoride (e.g., ClF₃ or IF₅), a gaseous fluoride (e.g., BF₃, NF₃, PF₅, SiF₄, or SF₆), a metal fluoride (e.g., LiF, NiF₂, AlF₃, or MgF₂), or the like. The fluorination treatment is preferably performed using a gaseous fluoride, which may be diluted with an inert gas. The fluorination treatment is preferably performed at room temperature or in a temperature range higher than or equal to 0° C. and lower than or equal to 250° C., which includes room temperature. Performing the fluorination treatment at higher than or equal to 0° C. enables adsorption of fluorine onto a surface of graphene.

Graphene or a graphene compound is suitable for the conductive material because of its excellent physical properties of high flexibility and high mechanical strength. Graphene or a graphene compound sometimes has a curved surface, thereby enabling low-resistant surface contact. Furthermore, graphene or a graphene compound has extremely high conductivity even with a small thickness in some cases and thus allows a conductive path to be formed in an active material layer efficiently even with a small amount. Hence, the use of graphene or a graphene compound as the conductive material can increase the area where the active material and the conductive material are in contact with each other. Graphene or a graphene compound may have a hole.

In the case where a negative electrode active material with a size less than or equal to 1 μm, such as a nanosilicon particle, is used, more conductive paths for connecting active materials are needed. In such a case, it is particularly preferred that graphene or a graphene compound that can efficiently form a conductive path even with a small amount be used.

It is particularly effective to use graphene or a graphene compound, which has the above-described properties, as a conductive material of a secondary battery that needs to be rapidly charged and discharged. For example, a secondary battery for a two-or four-wheeled vehicle, a secondary battery for a drone, or the like is required to be rapidly charged and discharged in some cases. In addition, a mobile electronic device or the like is required to have fast charge characteristics in some cases. Fast charging refers to charging at 400 mA/g or more, or charging at 1000 mA/g or more, for example. Fast discharging refers to discharging at 400 mA/g or more, or discharging at 1000 mA/g or more, for example.

### <Step S11>

In Step S11 shown in FIG. 4, a slurry 504 including a negative electrode active material, a binder, and the like is prepared, and the slurry 504 is applied to the negative electrode current collector 110, so that the negative electrode 106 is formed. The viscosity of the slurry is adjusted using a thickener or the like in order that the slurry can be easily applied to the negative electrode current collector 110.

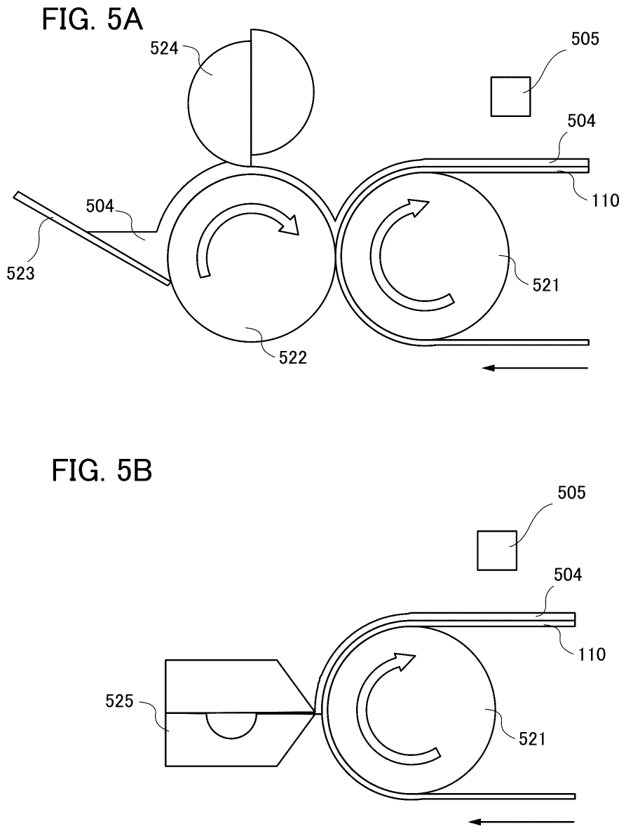

FIG. 5A illustrates a coating apparatus in which the slurry 504 including the negative electrode active material, the binder, and the like is applied to the negative electrode current collector 110. The coating apparatus is referred to as a comma coater. The slurry 504 may include a solvent, and water, ketone such as acetone, alcohol such as ethanol or isopropanol, ether, dioxane, acetonitrile, N-methyl-2-pyrrolidone (NMP), or the like can be used for the solvent.

The coating apparatus includes a back roll 521, a coating roll 522, a micro bar 524, and the like. The rolled negative electrode current collector (metal foil, typically copper foil) 110 to be the negative electrode current collector is moved by the back roll 521. The back roll 521 can rotate the coating roll 522. The slurry 504 is held by the bottom surface of a dam 523 and the coating roll 522 and the negative electrode current collector 110 is coated with the slurry 504 whose thickness is adjusted by the micro bar 524. Coating is also referred to as application. In the case where the thickness of the slurry 504 with which the negative electrode current collector 110 is coated is monitored, the coating apparatus preferably includes a slurry thickness measurement sensor 505.

FIG. 5B illustrates another example of a coating apparatus in which the slurry 504 is applied to the negative electrode current collector 110. The coating apparatus is referred to as a die coater. The coating apparatus includes a die 525, the back roll 521, and the like. The die 525 is an example of a coating nozzle and includes a manifold at the center of the die 525. The slurry 504 is supplied to the manifold by a pump and the slurry 504 in the manifold is pushed out toward the end of the die. The negative electrode current collector 110 moved by the rotation of the back roll 521 is coated with the pushed-out slurry 504. In the case where the thickness of the slurry 504 with which the negative electrode current collector 110 is coated is monitored, the coating apparatus preferably includes the slurry thickness measurement sensor 505.

The negative electrode 106 is obtained using such a coating apparatus. After the coating, pressure may be applied to the negative electrode 106 with a roller press machine as necessary. A linear pressure is higher than or equal to 10 kN/m and lower than or equal to 50 kN/m, preferably higher than or equal to 15 kN/m and lower than or equal to 25 KN/m. The upper and lower rolls of the roller press machine are heated to higher than or equal to 100° C., preferably higher than or equal to 120° C. Note that in the case of a slurry including a binder, the upper and lower rolls are heated to the melting point of the binder or higher. The negative electrode 106 is completed in this manner.

In the negative electrode 106, the thickness of the negative electrode active material layer 111 is greater than or equal to 100 μm and less than or equal to 300 μm, preferably greater than or equal to 110 μm and less than or equal to 150 μm. The loading level of the negative electrode active material is greater than or equal to 3 mg/cm² and less than or equal to 20 mg/cm², preferably greater than or equal to 12 mg/cm² and less than or equal to 18 mg/cm².

### <Step S12>

Next, in Step S12 shown in FIG. 4, the carbon sheet 115 is prepared.

### <Carbon Sheet 115>

The carbon sheet 115 is as described above, and a commercially available product can also be used. A commercially available CNT sheet has a thickness of greater than or equal to 400 nm and less than or equal to 500 nm per sheet. To obtain the carbon sheet 115 which satisfies a predetermined thickness, the commercially available sheets are stacked.

### <Step S13>

Next, in Step S13 shown in FIG. 4, the negative electrode 106 and the carbon sheet 115 are stacked, whereby the negative electrode structure 120 is obtained. The above-described binder may be used to bond the negative electrode 106 and the carbon sheet 115. The negative electrode structure 120 is obtained in this manner. After the negative electrode 106 and the carbon sheet 115 are overlapped with each other, pressure may be applied with a roller press machine as necessary. The upper and lower rolls of the roller press machine are heated to higher than or equal to 100° C., preferably higher than or equal to 120° C. Note that in the case where the binder is included, the upper and lower rolls are heated to the melting point of the binder or higher.

According to this example of the manufacturing method, the negative electrode structure 120 including the carbon sheet 115 can be obtained. The negative electrode structure 120 prevents the dendrite from reaching the positive electrode.

The contents in this embodiment can be combined with any of the contents in the other embodiments as appropriate.

### Embodiment 2

In this embodiment, a structure example of a secondary battery will be described.

### [Negative Electrode]

The negative electrode is as described in the above embodiment.

### [Positive Electrode]

The positive electrode includes a positive electrode active material layer and a positive electrode current collector. The positive electrode active material layer contains a positive electrode active material and may further contain at least one of a conductive material and a binder. The positive electrode active material described in the above embodiment can be used.

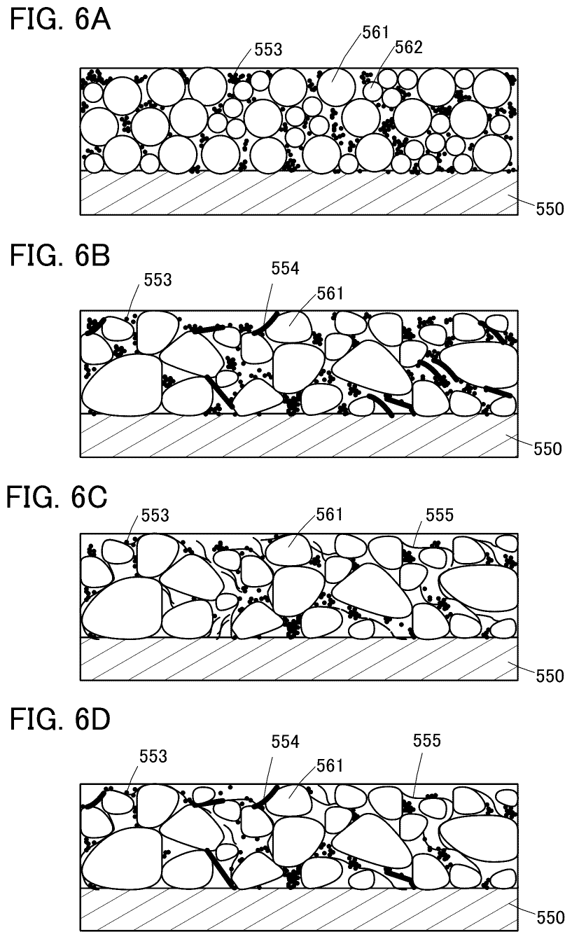

FIG. 6A illustrates an example of a schematic cross-sectional view of the positive electrode.

For example, metal foil can be used for a positive electrode current collector 550. The positive electrode can be formed by applying slurry onto metal foil and drying the slurry. Note that pressing may be performed after drying. The positive electrode is obtained by forming a positive electrode active material layer over the positive electrode current collector 550.

The positive electrode active material layer contains a positive electrode active material 561. A positive electrode active material is referred to as a positive electrode active material particle in some cases. The positive electrode active material 561 has a function of taking and/or releasing lithium ions in accordance with charging and discharging. For the positive electrode active material 561 used as one embodiment of the present invention, a material with less deterioration due to charging and discharging even at high charge voltage can be used. Note that for the positive electrode active material 561, two or more kinds of materials having different particle diameters can be used as long as the materials have less deterioration due to charging and discharging even at high charge voltage.

Any of the conductive materials described in the above embodiment can be appropriately selected as a conductive material. In FIG. 6A, a carbon black 553 is illustrated as a conductive material.

In the positive electrode of the secondary battery, a binder may be mixed in order to fix the positive electrode current collector 550 such as metal foil and the positive electride active material. Since the binder is a high molecular material, a large amount of binder lowers the proportion of the active material in the positive electrode, thereby reducing the discharge capacity of the secondary battery. Therefore, the amount of binder mixed is preferably reduced to a minimum. In FIG. 6A, a region not filled with any of the positive electrode active material 561, a second positive electrode active material 562, and the carbon black 553 indicates a space or a binder.

Although FIG. 6A illustrates an example in which the positive electrode active material 561 has a spherical shape, there is no particular limitation. For example, the cross-sectional shape of the positive electrode active material 561 may be an ellipse, a rectangle, a trapezoid, a pyramid, a polygon with rounded corners, or an asymmetrical shape. For example, FIG. 6B illustrates an example in which the positive electrode active material 561 has a polygon shape with rounded corners.

In the positive electrode in FIG. 6B, graphene 554 is used as a carbon material used as the conductive material. FIG. 6B illustrates a positive electrode active material layer in which the positive electrode active material 561, the graphene 554, and the carbon black 553 are provided over the positive electrode current collector 550.

In the step of mixing the graphene 554 and the carbon black 553 to obtain an electrode slurry, the weight of mixed carbon black is preferably 1.5 times to 20 times, further preferably 2 times to 9.5 times the weight of graphene.

When the graphene 554 and the carbon black 553 are mixed in the above range, the carbon black 553 is excellent in dispersion stability and less likely to be aggregated at the time of preparing the slurry. Furthermore, a positive electrode containing the graphene 554 and the carbon black 553 which are mixed in the above range can have higher density than that including only the carbon black 553 as the conductive material. A higher electrode density leads to higher capacity per unit weight.

A positive electrode containing a first carbon material (graphene) and a second carbon material (acetylene black) which are mixed in the above range enables fast charging, although having lower electrode density than a positive electrode containing only graphene as a conductive material. Thus, use of such a positive electrode for lithium-ion secondary batteries for vehicles is particularly effective.

FIG. 6C illustrates an example of a positive electrode using carbon fiber 555 instead of graphene. FIG. 6C illustrates an example different from that in FIG. 6B. With the use of the carbon fiber 555, aggregation of the carbon black 553 can be prevented and the dispersibility can be increased.

In FIG. 6C, a region that is not filled with any of the positive electrode active material 561, the carbon fiber 555, and the carbon black 553 indicates a space or a binder.

FIG. 6D illustrates another example of a positive electrode. FIG. 6D illustrates an example in which the carbon fiber 555 is used in addition to the graphene 554. With the use of both the graphene 554 and the carbon fiber 555, aggregation of carbon black such as the carbon black 553 can be prevented and the dispersibility can be further increased.

In FIG. 6D, a region not filled with any of the positive electrode active material 561, the carbon fiber 555, the graphene 554, and the carbon black 553 indicates a space or a binder.

A lithium-ion secondary battery can be fabricated by using any one of the positive electrodes in FIGS. 6A to 6D; setting, in a container (e.g., an exterior body or a metal can), a stack in which a separator is provided over the positive electrode and a negative electrode is provided over the separator; and filling the container with a liquid electrolyte.

### [Electrolyte Solution]

The electrolyte solution contains an organic solvent; the organic solvent of the electrolyte of one embodiment of the present invention is not limited to a liquid at 25° C. and may be a solid at 25° C. or a semi-solid at normal temperature. Note that the organic solvent of the electrolyte of one embodiment of the present invention is preferably a liquid in a wide temperature range from temperatures below freezing to high temperatures; however, the present invention is not limited thereto. The organic solvent may be a liquid, a solid, or a semi-solid in a wide temperature range from temperatures below freezing to high temperatures.

As an organic solvent, an aprotic organic solvent is preferably used. For example, one of ethylene carbonate (EC), propylene carbonate (PC), butylene carbonate, chloroethylene carbonate, vinylene carbonate (VC), γ-butyrolactone, γ-valerolactone, dimethyl carbonate (DMC), diethyl carbonate (DEC), ethyl methyl carbonate (EMC), 1,3-propanesultone (PS), fluoroethylene carbonate (FEC), methyl 3,3,3-trifluoropropionate (MTFP), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more of these solvents can be used in an appropriate combination in an appropriate ratio. An electrolyte solution containing vinylene carbonate (VC) or fluoroethylene carbonate (FEC) is preferable because the dendrite tends to be thick and thus the penetration of the separator can be inhibited. In that case, vinylene carbonate (VC) or fluoroethylene carbonate (FEC) is preferably used not as a main component of the electrolyte solution but as an additive agent. Typically, ethylene carbonate (EC) and diethyl carbonate (DEC) are preferably used at a volume ratio of 3:7.

PS has a HOMO level and a LUMO level equivalent to those of EC and DEC; thus, PS is less likely to be oxidized and reduced even at a high cut-off voltage, and is likely to be a high molecule when decomposed on the surface of the positive electrode active material. Accordingly, PS is advantageous in that it is unlikely to be gasified by becoming a decomposition product with a small molecular weight. Thus, the electrolyte solution preferably contains PS at higher than or equal to 0.1 wt % and lower than or equal to 10 wt %, further preferably higher than or equal to 0.25 wt % and lower than or equal to 7.5 wt %.

FEC, which is one of cyclic carbonates, has a high dielectric constant and thus has an effect of promoting dissociation of a lithium salt when used in an organic solvent. Meanwhile, because FEC includes a substituent with an electron-withdrawing property, a lithium ion is desolvated with FEC more easily than with EC. Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is one of linear carbonates, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP), which does not include a substituent with an electron-withdrawing property, MTFP may solvate a lithium ion when used for the electrolyte solution. In the case of using a mixed organic solvent containing both FEC and MTFP, y in the volume ratio FEC:MTFP=1:y preferably satisfies 2≤y≤20, further preferably 4≤y≤9.

It is preferable that the above-described organic solvent be highly purified and contain a small amount of dust particles or molecules other than constituent molecules of the organic solvent (hereinafter also simply referred to as impurities and include oxygen (O₂), water (H₂O), and moisture). It is preferable that the organic solvent pass through appropriate purification and generation of a reaction by-product in synthesis be inhibited. Specifically, the impurity in the electrolyte is less than or equal to 100 ppm, preferably less than or equal to 50 ppm, further preferably less than 10 ppm. The concentration of moisture among the impurity can be detected by Karl Fischer titration.

Furthermore, it is preferable that peaks attributed to impurities in the above-described organic solvent be hardly observed by NMR measurement or the like. The expression “hardly observed” includes the case where the ratio of the integral area of the peak attributed to impurities to the integral area of the peak attributed to the main component (such a ratio is simply referred to as an integral ratio) is less than or equal to 0.005, preferably less than or equal to 0.002. An apparatus used for the NMR measurement is not particularly limited, and for example, “AVANCE III 400” produced by Bruker Corporation can be used. Among the five peaks of acetonitrile derived from acetonitrile-d₃ used in a solvent in the 1H-NMR measurement, the center peak can be 1.94 ppm.

For example, in the case of MTFP, it is known that when 1H-NMR is measured using an acetonitrile-d₃ solvent, four peaks appear at δ of greater than or equal to 3.29 ppm and less than or equal to 3.43 ppm. However, in the case where another peak appears in the vicinity of the above range, for example, another peak appears at δ of greater than or equal to 3.24 ppm and less than or equal to 3.29 ppm, the peak is probably derived from impurities. Accordingly, when the ratio (integral ratio) of a peak area greater than or equal to 3.24 ppm and less than or equal to 3.29 ppm to a peak area greater than or equal to 3.29 ppm and less than or equal to 3.43 ppm is less than or equal to 0.005, preferably less than or equal to 0.002, peaks attributed to impurities are hardly observed.

In order to form a coating film (solid electrolyte interphase film) at the interface between the electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate) borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %. In the case where ethylene carbonate (EC) and diethyl carbonate (DEC) are used, it is preferable to use a solution obtained by adding 2 wt % of vinylene carbonate (VC) to a mixed organic solvent where ethylene carbonate (EC) and diethyl carbonate (DEC) are mixed at a volume ratio of 3:7 and a lithium salt described later is dissolved.

Alternatively, the use of one or more kinds of ionic liquids (room temperature molten salts) that are unlikely to burn and volatize as the solvent of the electrolyte solution can prevent a power storage device from exploding and catching fire even when the power storage device internally shorts out or the internal temperature increases owing to overcharging or the like. An ionic liquid contains a cation and an anion, specifically, an organic cation and an anion. Examples of the organic cation used for the electrolyte solution include aliphatic onium cations such as a quaternary ammonium cation, a tertiary sulfonium cation, and a quaternary phosphonium cation, and aromatic cations such as an imidazolium cation and a pyridinium cation. Examples of the anion used for the electrolyte solution include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

As the electrolyte dissolved in the above solvent (also referred to as a lithium salt), one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate) borate (Li(C₂O₄)₂ or LiBOB) can be used, or two or more of these lithium salts can be used in an appropriate combination and in an appropriate ratio.

The electrolyte solution is preferably highly purified and contains a small amount of dust particles or elements other than the constituent elements of the electrolyte solution (hereinafter, also simply referred to as impurities). Specifically, the weight ratio of impurities to the electrolyte solution is preferably less than or equal to 1%, further preferably less than or equal to 0.1%, still further preferably less than or equal to 0.01%.

Alternatively, a polymer gel electrolyte obtained in such a manner that a polymer is swelled with an electrolyte solution may be used.

When a polymer gel electrolyte is used, safety against liquid leakage and the like is improved. Moreover, a secondary battery can be thinner and more lightweight.

As a gelled polymer, a silicon gel, an acrylic gel, an acrylonitrile gel, a polyethylene oxide-based gel, a polypropylene oxide-based gel, a fluorine-based polymer gel, or the like can be used. For example, a polymer having a polyalkylene oxide structure, such as polyethylene oxide (PEO), PVDF, polyacrylonitrile, or a copolymer containing any of them can be used. For example, PVDF-HFP, which is a copolymer of PVDF and hexafluoropropylene (HFP), can be used. The formed polymer may be porous.

In addition, as the electrolyte solution, a solid electrolyte including an inorganic material such as a sulfide-based or oxide-based inorganic material, or a solid electrolyte including a polymer material such as a polyethylene oxide (PEO)-based polymer material may alternatively be used. When the solid electrolyte is used, a separator or a spacer is not necessary. Furthermore, the battery can be entirely solidified; therefore, there is no risk of liquid leakage and thus the safety of the battery is dramatically improved.

### [Separator]

As a separator, for example, a fiber containing cellulose such as paper; nonwoven fabric; a glass fiber; ceramics; a synthetic fiber using nylon (polyamide), vinylon (polyvinyl alcohol-based fiber), polypropylene (referred to as PP), polyimide (referred to as PI), polyester, acrylic, polyolefin, or polyurethane; or the like can be used. The separator can have a porosity in thickness higher than or equal to 35% and lower than or equal to 90%, preferably higher than or equal to 60% and lower than or equal to 85%. A separator using polypropylene can have a porosity higher than or equal to 35% and lower than or equal to 45%. A separator using polyimide can have a porosity higher than or equal to 75% and lower than or equal to 85%. The thickness of the separator is preferably greater than or equal to 10 μm and less than or equal to 80 μm, further preferably greater than or equal to 20 μm and less than or equal to 60 μm. The separator using polyimide is preferable because it can have a high porosity and can have a large thickness (typically, a thickness greater than or equal to 50 μm and less than or equal to 60 μm).

The separator is preferably processed into a bag-like shape to enclose one of the positive electrode and the negative electrode.

The separator may have a multilayer structure. For example, an organic material film of polypropylene, polyethylene, or the like can be coated with a ceramics-based material, a fluorine-based material, a polyamide-based material, a mixture thereof, or the like. Examples of the ceramics-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

With the use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As a film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

This embodiment can be implemented in appropriate combination with any of the other embodiments.

### Embodiment 3

In this embodiment, an electrolyte solution that is needed to achieve a secondary battery having excellent discharge characteristics even in a low-temperature environment is described.

The low temperature refers to a temperature below freezing. In charge at a low temperature, an energy barrier at the time of extracting lithium ions from a positive electrode active material tends to high. That is, it can be said that overvoltage required for extracting lithium ions from the positive electrode active material becomes larger as the temperature of charging environment becomes lower. That is, the positive electrode active material might be exposed to high voltage (a higher potential than a lithium potential) in charge at a low temperature. In other words, in charge at a low temperature, charge capacity might be decreased when the positive electrode active material is not exposed to high voltage.

Thus, a positive electrode active material that can withstand a high voltage and obtain high charge capacity in charge at a low temperature is preferably used for a positive electrode active material contained in a secondary battery having excellent charge characteristics and discharge characteristics even in a low-temperature environment.

For an electrolyte solution included in a secondary battery having excellent charge characteristics and discharge characteristics even in a low-temperature environment, a material having excellent lithium ion conductivity even when charging and/or discharging (charging and discharging) are/is performed in a low-temperature environment is preferably used.

An electrolyte solution which is preferable for a lithium-ion secondary battery having an excellent charge characteristic and an excellent discharge characteristic even in a low-temperature environment will be described in detail below.

### <Electrolyte Solution 1 Suitable for Low-Temperature Environment>

For a mixed organic solvent used for the electrolyte solution, it is possible to use a material having excellent lithium ion conductivity even when charging and/or discharging (charging and discharging) are/is performed in a low-temperature environment (e.g., 0° C., −20° C., preferably −30° C., further preferably-40° C.).

The mixed organic solvent preferably contains two or more selected from a fluorinated cyclic carbonate and a fluorinated linear carbonate.

As the fluorinated cyclic carbonate, fluoroethylene carbonate (FEC or FIEC), difluoroethylene carbonate (DFEC or F2EC), trifluoroethylene carbonate (F3EC), or tetrafluoroethylene carbonate (F4EC) can be used, for example. Note that DFEC has isomers such as a cis-4,5 isomer and a trans-4,5 isomer. Each of these fluorinated cyclic carbonates includes a substituent with an electron-withdrawing property and is thus presumed to allow the solvation energy of a lithium ion to be low.

Structural Formula (H10) below represents FEC. The substituent with an electron-withdrawing property in FEC is an F group.

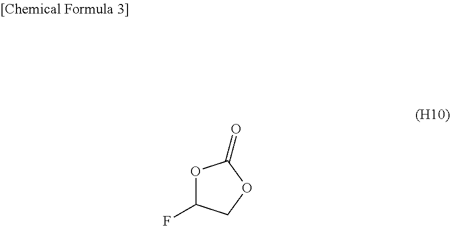

An example of the fluorinated linear carbonate is methyl 3,3,3-trifluoropropionate. Structural Formula (H22) below represents methyl 3,3,3-trifluoropropionate. An abbreviation of methyl 3,3,3-trifluoropropionate is MTFP. The substituent with an electron-withdrawing property in MTFP is a CF₃ group.

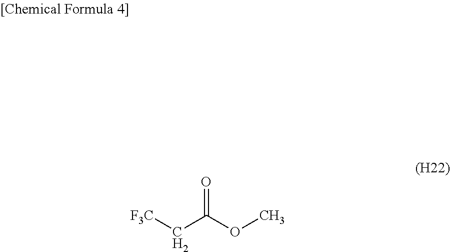

An example of the fluorinated linear carbonate is trifluoromethyl 3,3,3-trifluoropropionate. Structural Formula (H23) below represents trifluoromethyl 3,3,3-trifluoropropionate. The substituent with an electron-withdrawing property is a CF₃ group.

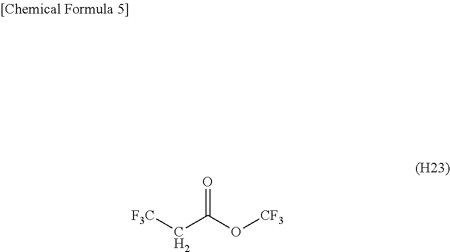 [SMILES: O=C(CC(F)(F)F)OC(F)(F)F]

An example of the fluorinated linear carbonate is trifluoromethyl propionate. Structural Formula (H24) below represents trifluoromethyl propionate. The substituent with an electron-withdrawing property is a CF₃ group.

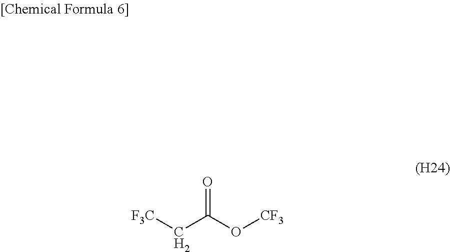 [SMILES: O=C(CC(F)(F)F)OC(F)(F)F]

An example of the fluorinated linear carbonate is methyl 2,2-difluoropropionate. Structural Formula (H25) below represents methyl 2,2-difluoropropionate. The substituent with an electron-withdrawing property is a CF₂ group.

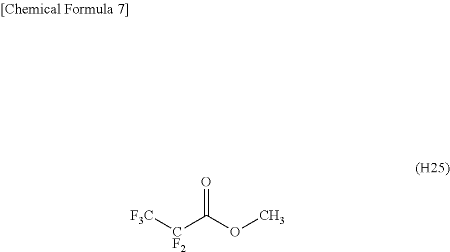

### <FEC and MTFP>

The mixed organic solvent described in this embodiment preferably contains FEC and MTFP. The reason for this is as follows.

FEC, which is one of cyclic carbonates, has a high dielectric constant and thus has an effect of promoting dissociation of a lithium salt when used in an organic solvent. Meanwhile, because FEC includes a substituent with an electron-withdrawing property, a lithium ion is desolvated with FEC more easily than with ethylene carbonate (EC). Specifically, the solvation energy of a lithium ion is lower in FEC than in EC, which does not include a substituent with an electron-withdrawing property. Thus, lithium ions are likely to be extracted from surfaces of a positive electrode active material and a negative electrode active material, which can reduce an internal resistance of a secondary battery. In addition, FEC has a deep highest occupied molecular orbital (HOMO) level and is thus not easily oxidized, meaning high oxidation resistance. On the other hand, FEC disadvantageously has high viscosity. In view of this, a mixed organic solvent containing not only FEC but also MTFP is preferably used for the electrolyte solution. MTFP, which is a linear carbonate, can have an effect of reducing the viscosity of an electrolyte solution or maintaining the viscosity at room temperature (typically, 25° C.) even at low temperatures (typically, 0° C.). Furthermore, while the solvation energy is lower in MTFP than in methyl propionate (abbreviation: MP), which does not include a substituent with an electron-withdrawing property, MTFP may solvate a lithium ion when used for the electrolyte solution.

The HOMO levels, the solvation energy, the measured melting points, and the like are collectively shown in the table below.

TABLE 1

| Name of organic compound | | | | |
|---|---|---|---|---|
| (abbreviation) | FEC | MTFP | EC | MP |
| Structural Formula | 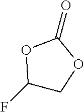 | 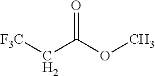 | 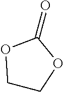 | 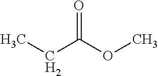 |
| HOMO level [eV] | −8.71 | −8.15 | −8.23 | −7.56 |
| Solvation energy [eV] | 5.39 | 4.33 to 5.38 | 5.79 | 4.45 to 5.22 |
| Measured melting point [° C.] | 17 | Unknown | 38 | −87.5 |

FEC and MTFP having such physical properties are preferably mixed in the volume ratio of x:100-x (where 5≤x≤30, preferably 10≤x≤20) with the total content of these two organic solvents of 100 vol %. In other words, MTFP and FEC are preferably mixed such that the amount of MTFP is larger than that of FEC in the mixed organic solvent. Note that the above volume ratio may be the volume ratio of the mixed organic solvents measured before mixing the organic solvents, and the mixed organic solvents may be mixed at room temperature (typically 25° C.). The mixed organic solvent in which FEC and MTFP are mixed is preferable because the viscosity that enables a secondary battery to operate is exhibited and appropriate viscosity is maintained even in a low-temperature environment.

A general solvent used for a secondary battery is solidified at approximately −20° C.; thus, it is difficult to fabricate a secondary battery that can be charged and discharged at −30° C., preferably at −40° C. However, the mixed organic solvent described as an example in this embodiment can have a freezing point lower than or equal to −30° C., preferably lower than or equal to −40° C., so that a secondary battery that can be charged and discharged even in a low-temperature environment can be achieved. As a result, a secondary battery capable of being charged and discharged in a wide temperature range including at least a low-temperature environment can be achieved.

Although FEC is described above as a typical example, the following also apply to any of the organic compounds described above as the fluorinated cyclic carbonate: having an effect of promoting dissociation of a lithium salt; having low solvation energy that brings easy disconnection of a bond between a lithium ion and a solvent; and having high viscosity and being difficult to use alone at a temperature below freezing.

Although MTFP is described above as a typical example, any of the organic compounds described as the fluorinated linear carbonate can be regarded as having an effect of lowering or maintaining the viscosity of the electrolyte solution of one embodiment of the present invention. Therefore, a lithium-ion secondary battery that can be charged and discharged in a low-temperature environment can be provided as long as the mixed organic solvent of one embodiment of the present invention contains a fluorinated cyclic carbonate and a fluorinated linear carbonate.

### <Electrolyte Solution 2 Suitable for Low-Temperature Environment>

As a mixed organic solvent used for an electrolyte solution, ethylene carbonate (EC), ethyl methyl carbonate (EMC), and dimethyl carbonate (DMC) are preferably mixed in the volume ratio of x:y: 100-x-y (where 5≤x≤35 and 0<y<65) with the total content of EC, EMC, and DMC of 100 vol %. More specifically, a mixed organic solvent containing EC, EMC, and DMC in the ratio of 30:35:35 by volume can be used. Note that the above volume ratio may be the volume ratio of the mixed organic solvent before mixing, and the mixed organic solvent may be mixed at room temperature (typically 25° C.).

EC, which is a cyclic carbonate, has a high dielectric constant and thus has an effect of promoting dissociation of a lithium salt. Meanwhile, because EC has high viscosity and has a high freezing point (melting point) of 38° C., it is difficult to use EC alone as the solvent in a low-temperature environment. Then, the solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, the freezing point is −43° C. An electrolyte solution formed using a mixed organic solvent where EC, EMC, and DMC having such physical properties are mixed in the volume ratio of x:y:100-x-y (where 5≤x≤35 and 0<y<65) with the total content of these three solvents of 100 vol % has a characteristic in which the freezing point is lower than or equal to −40° C.

A general electrolyte solution used for a secondary battery can be solidified even at approximately −20° C.; thus, it is difficult to fabricate a battery that can be charged and discharged at −40° C. Since the electrolyte solution described as an example in this embodiment has a freezing point of −40° C. or lower, a secondary battery can be charged and discharged even in an extremely low-temperature environment of −40° C.

As a lithium salt dissolved in the above solvent, any of lithium salts described below can be used. For example, at least one of lithium salts such as LiPF₆, LiClO₄, LiAsF₆, LiBF₄, LiAlCl₄, LISCN, LiBr, LiI, Li₂SO₄, Li₂B₁₀Cl₁₀, Li₂B₁₂Cl₁₂, LiCF₃SO₃, LiC₄F₉SO₃, LIC (CF₃SO₂)₃, LiC(C₂F₅SO₂)₃, LiN(CF₃SO₂)₂, LiN(C₄F₉SO₂) (CF₃SO₂). LiN(C₂F₅SO₂)₂, and lithium bis(oxalate) borate (LiBOB) can be used, or two or more of these lithium salts can be used in an appropriate combination with an appropriate ratio. The lithium salt dissolved in the above solvent is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the above solvent. A specific usage example is that LiPF₆ is preferably more than or equal to 0.5 mol/L and less than or equal to 1.5 mol/L, further preferably more than or equal to 0.7 mol/L and less than or equal to 1.3 mol/L, still further preferably more than or equal to 0.8 mol/L and less than or equal to 1.2 mol/L with respect to the volume of the above solvent.

The mixed organic solvent is preferably highly purified and contains a small amount of dust particles and elements other than the constituent elements of the electrolyte solution (hereinafter also simply referred to as impurities). Specifically, the weight ratio of impurities to the electrolyte solution is preferably less than or equal to 1%, further preferably less than or equal to 0.1%, still further preferably less than or equal to 0.01%.

In order to form a coating film (solid electrolyte interphase film) at the interface between the electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate) borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

In Electrolyte solution 2, the material described in Electrolyte solution 1 can be used for the lithium salt. Also for the additive agent, the material described in Electrolyte solution 1 can be used.

Although an example of an electrolyte solution that can be used for the secondary battery of one embodiment of the present invention is described above, the electrolyte solution that can be used for the secondary battery of one embodiment of the present invention should not be construed as being limited to the example. Another material can be used as long as it has high lithium ion conductivity even when the lithium ion battery is charged and discharged in a low-temperature environment.

The contents in this embodiment can be combined with any of the contents in the other embodiments as appropriate.

### Embodiment 4

In this embodiment, embodiment examples of a secondary battery will be described.

### [Coin-Type Secondary Battery]

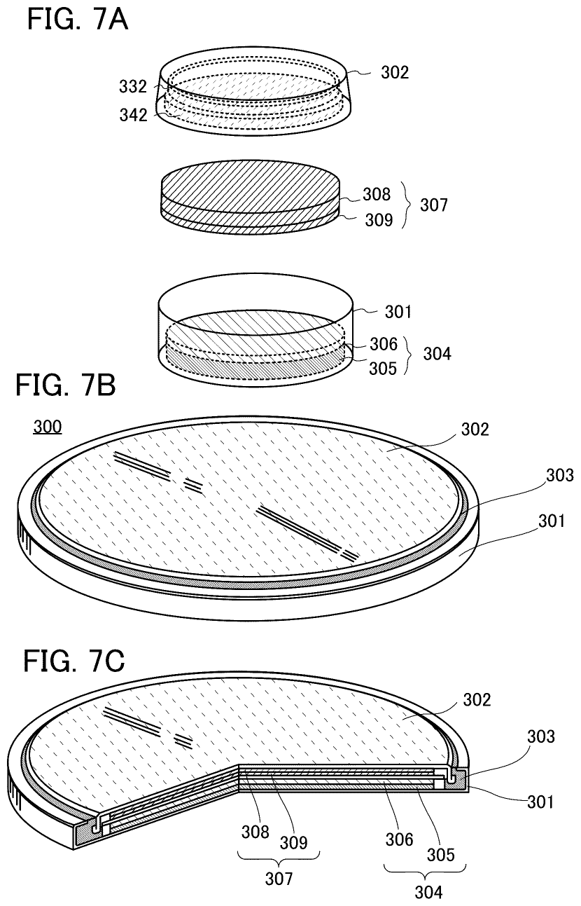

An example of a coin-type secondary battery is described. FIGS. 7A, 7B, and 7C are an exploded perspective view, an external view, and a cross-sectional view of a coin-type (single-layer flat) secondary battery, respectively. Coin-type secondary batteries are mainly used in small electronic devices. In this specification and the like, coin-type secondary batteries include button-type secondary batteries.

For easy understanding, FIG. 7A is a schematic view showing overlap (a vertical relation and a positional relation) between components. Thus, FIG. 7A and FIG. 7B do not completely correspond with each other.

FIG. 7A illustrates a state where a positive electrode 304, a negative electrode 307, a spacer 342, and a washer 332 overlap with each other and are sealed with a negative electrode can 302 and a positive electrode can 301. Note that FIG. 7A does not illustrate the electrolyte and the separator described in the above embodiments. The spacer 342 and the washer 332 are used to protect the inside or fix the position of the components inside the cans at the time when the positive electrode can 301 and the negative electrode can 302 are bonded with pressure. For the spacer 342 and the washer 332, stainless steel or an insulating material is used.

The positive electrode 304 is a stack in which a positive electrode active material layer 306 is formed over a positive electrode current collector 305.

FIG. 7B is a perspective view of a completed coin-type secondary battery 300.

In the coin-type secondary battery 300, the positive electrode can 301 doubling as a positive electrode terminal and the negative electrode can 302 doubling as a negative electrode terminal may be insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The positive electrode can 301 and the negative electrode can 302 are electrically connected to the positive electrode 304 and the negative electrode 307, respectively.

Note that only one side of each of the positive electrode 304 and the negative electrode 307 used for the coin-type secondary battery 300 is provided with an active material layer. As illustrated in FIG. 7C, the coin-type secondary battery 300 is manufactured in the following manner: the positive electrode 304, the negative electrode 307, and the negative electrode can 302 are stacked in this order with the positive electrode can 301 at the bottom; the positive electrode can 301 and the negative electrode can 302 are bonded with pressure with the gasket 303 therebetween.

When the secondary battery of the present invention is used as the coin-type secondary battery 300, the coin-type secondary battery 300 can have high reliability. Furthermore, when the secondary battery of the present invention is used as the coin-type secondary battery 300, the coin-type secondary battery 300 can have favorable low-temperature characteristics.

### [Cylindrical Secondary Battery]

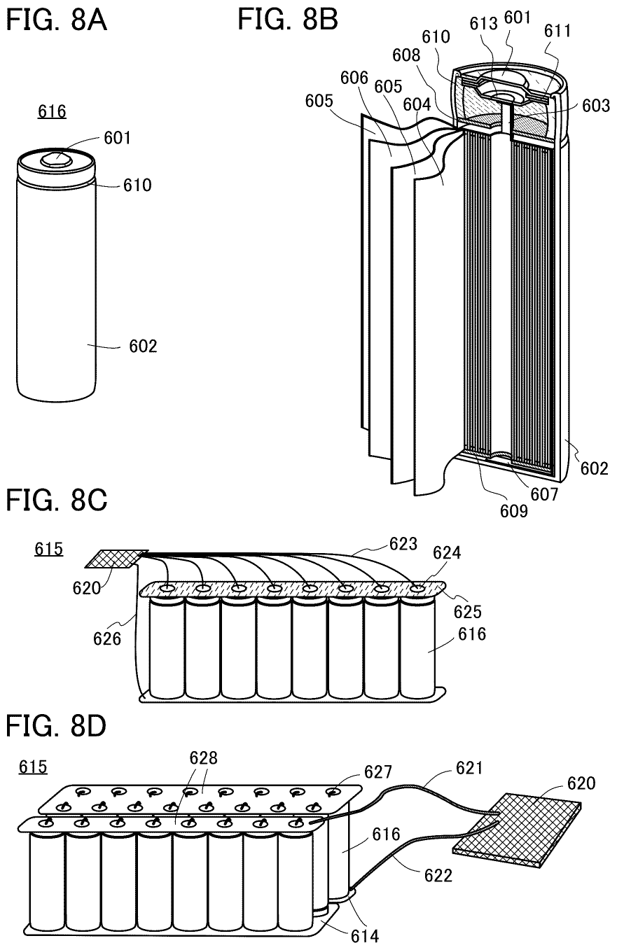

An example of a cylindrical secondary battery is described with reference to FIG. 8A. As illustrated in FIG. 8A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 8B schematically illustrates a cross section of the cylindrical secondary battery. The cylindrical secondary battery illustrated in FIG. 8B includes the positive electrode cap (battery cap) 601 on the top surface and the battery can (outer can) 602 on the side and bottom surfaces. The positive electrode cap 601 and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a strip-like electrolyte layer 605 located therebetween is provided. Although not illustrated, the battery element is wound around the central axis. One end of the battery can 602 is closed and the other end thereof is open. Inside the battery can 602, the battery element in which the positive electrode, the negative electrode, and the separator are wound is provided between a pair of insulating plates 608 and 609 that face each other. The inside of the battery can 602 provided with the battery element is filled with a electrolyte of one embodiment of the present invention (not illustrated).

Since the positive electrode and the negative electrode of the cylindrical storage battery are wound, active materials are preferably formed on both sides of the current collectors. Although FIGS. 8A to 8D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

A positive electrode terminal (positive electrode current collecting lead) 603 is connected to the positive electrode 604, and a negative electrode terminal (negative electrode current collecting lead) 607 is connected to the negative electrode 606. The positive electrode terminal 603 can be formed using a metal material such as aluminum. The negative electrode terminal 607 can be formed using a metal material such as copper. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a positive temperature coefficient (PTC) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based ceramic material or the like can be used for the PTC element.

FIG. 8C illustrates an example of a power storage system 615. The power storage system 615 includes a plurality of secondary batteries 616 and is also referred to as a battery pack in some cases. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used, for example.

FIG. 8D illustrates an example of the power storage system 615. The power storage system 615 includes the plurality of secondary batteries 616, and the plurality of secondary batteries 616 are provided between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 8D, the power storage system 615 is electrically connected to the control circuit 620 through a wiring 621 and a wiring 622. The wiring 621 is electrically connected to the positive electrodes of the plurality of secondary batteries 616 through the conductive plate 628. The wiring 622 is electrically connected to the negative electrodes of the plurality of secondary batteries 616 through the conductive plate 614.

When the secondary battery of the present invention is used as the cylindrical secondary battery 616, the cylindrical secondary battery 616 can have high reliability. Furthermore, when the secondary battery of the present invention is used as the cylindrical secondary battery 616, the cylindrical secondary battery 616 can have favorable low-temperature characteristics.

### [Other Structure Examples of Secondary Battery]

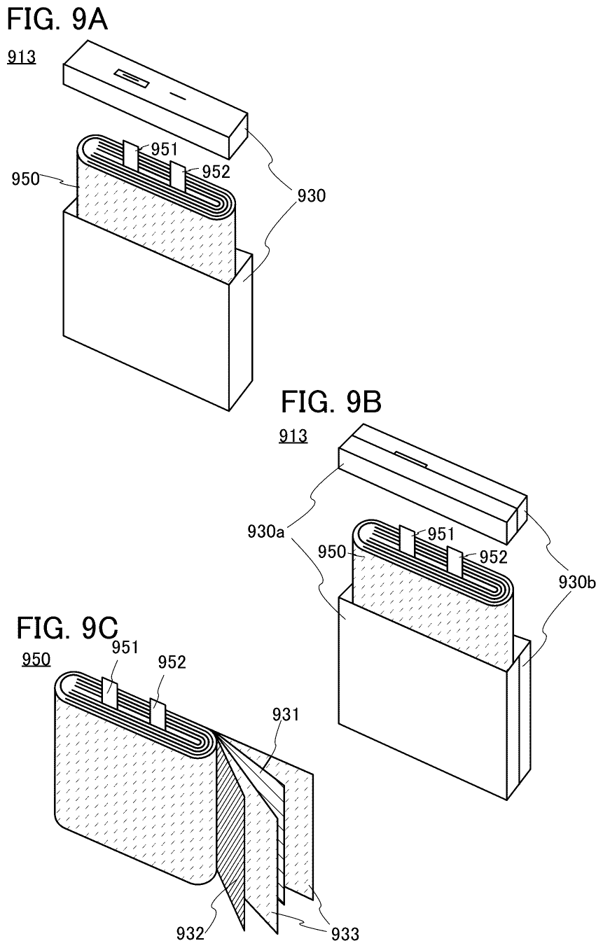

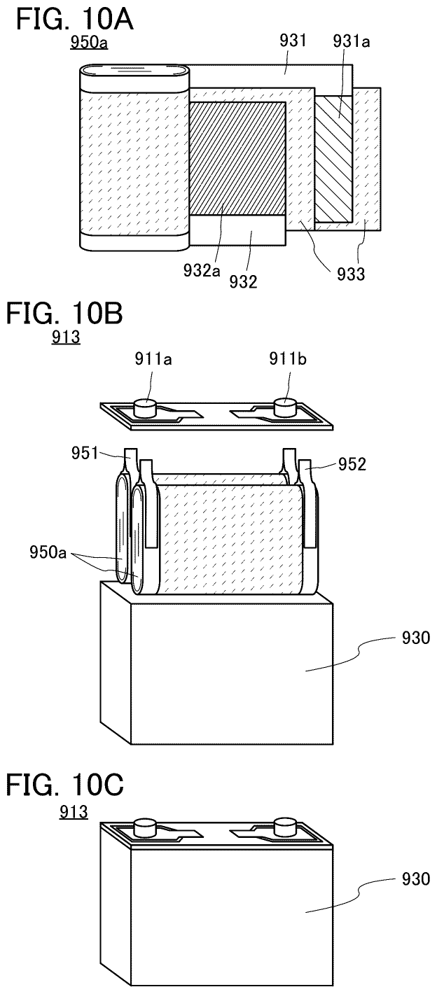

Structure examples of secondary batteries are described with reference to FIGS. 9A to 9C and FIGS. 10A to 10C.

A secondary battery 913 illustrated in FIG. 9A includes a wound body 950 provided with a terminal 951 and a terminal 952 inside a housing 930. The wound body 950 is immersed in the electrolyte of one embodiment of the present invention inside the housing 930. The terminal 952 is in contact with the housing 930. The use of an insulator or the like prevents contact between the terminal 951 and the housing 930. Note that in FIG. 9A, the housing 930 divided into two pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a stack of a metal material and a resin material can be used.

Note that as illustrated in FIG. 9B, the housing 930 in FIG. 9A may be formed using a plurality of materials. For example, in the secondary battery 913 in FIG. 9B, a housing 930a and a housing 930b are attached to each other, and the wound body 950 is provided in a region surrounded by the housing 930a and the housing 930b.

For the housing 930a, a stack of a metal material and a resin material can be used, for example. In particular, when an organic resin, which is a resin material, is formed for the side on which an antenna is formed, blocking of an electric field by the secondary battery 913 can be inhibited. When an electric field is not significantly blocked by the housing 930a, an antenna may be provided inside the housing 930a. For the housing 930b, a metal material or a stack of a metal material and a resin material can be used, for example.

FIG. 9C illustrates the structure of the wound body 950. The wound body 950 includes a negative electrode 931, a positive electrode 932, and an electrolyte layer 933. The wound body 950 is obtained by winding a sheet of a stack in which the negative electrode 931 and the positive electrode 932 overlap with the electrolyte layer 933 therebetween. Note that a plurality of stacks each including the negative electrode 931, the positive electrode 932, and the electrolyte layer 933 may be overlaid.

As illustrated in FIGS. 10A to 10C, the secondary battery 913 may include a wound body 950a. The wound body 950a illustrated in FIG. 10A includes the negative electrode 931, the positive electrode 932, and the electrolyte layers 933. The negative electrode 931 includes a negative electrode active material layer 931a. The positive electrode 932 includes a positive electrode active material layer 932a.

The electrolyte layer 933 has a larger width than the negative electrode active material layer 931a and the positive electrode active material layer 932a, and is wound to overlap the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high degree of safety and high productivity.

As illustrated in FIG. 10B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 10C, the wound body 950a is covered with the housing 930, whereby the secondary battery 913 is completed. The housing 930 is preferably provided with a safety valve, an overcurrent protection element, and the like. A safety valve is a valve to be released by a predetermined internal pressure of the housing 930 and can prevent the secondary battery 913 from exploding.

As illustrated in FIG. 10B, the secondary battery 913 may include a plurality of wound bodies 950a. The use of the plurality of wound bodies 950a enables the secondary battery 913 to have higher charge and discharge capacity. The description of the secondary battery 913 in FIGS. 9A to 9C can be referred to for the other components of the secondary battery 913 in FIGS. 10A and 10B.

When the secondary battery of the present invention is used as the secondary battery 913 with a wound body, the secondary battery 913 can have high reliability. Furthermore, when the secondary battery of the present invention is used as the secondary battery 913 with a wound body, the secondary battery 913 can have favorable low-temperature characteristics.

The contents in this embodiment can be combined with any of the contents in the other embodiments as appropriate.

### Embodiment 5

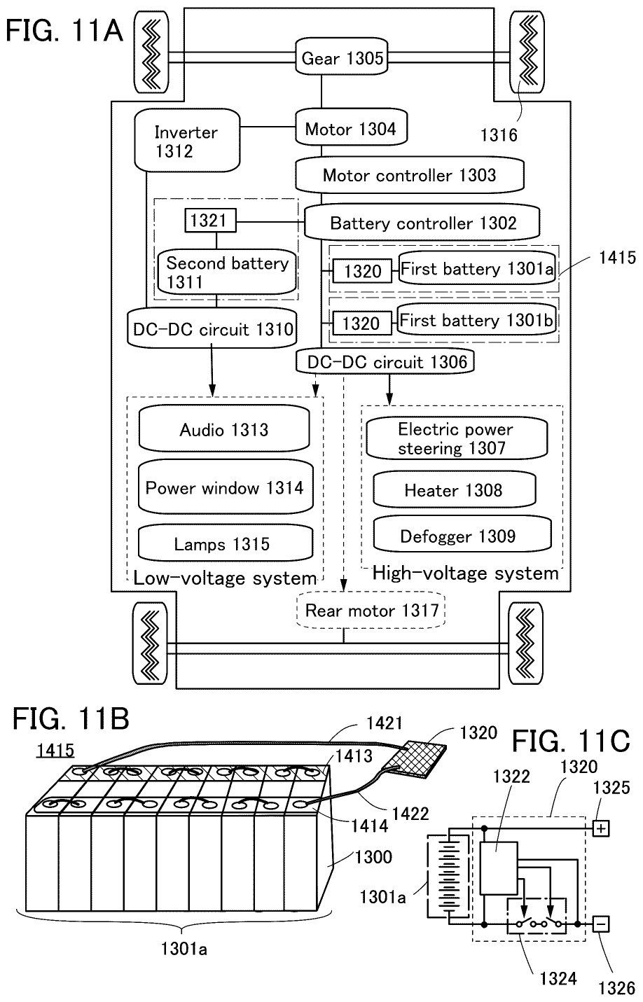

In this embodiment, an example of application to an electric vehicle (EV) will be described with reference to FIGS. 11A to 11C.

As illustrated in FIG. 11A, an electric vehicle is provided with first batteries 1301a and 1301b as main secondary batteries for driving and a second battery 1311 that supplies electric power to an inverter 1312 for starting a motor 1304. When the secondary battery of the present invention is used as the first batteries 1301a and 1301b, the first batteries 1301a and 1301b can have high reliability. Furthermore, when the secondary battery of the present invention is used as the above-described first batteries 1301a and 1301b, the above-described first batteries 1301a and 1301b can have favorable low-temperature characteristics.

The second battery 1311 is also referred to as a cranking battery and a starter battery. The second battery 1311 specifically needs high output and does not necessarily have high capacity, and the capacity of the second battery 1311 is lower than that of the first batteries 1301a and 1301b.

The internal structure of the first battery 1301a may be a wound structure or a stacked-layer structure. Alternatively, the first battery 1301a may be the all-solid-state battery in Embodiment 6. Using the all-solid-state battery in Embodiment 6 as the first battery 1301a achieves high capacity, a high degree of safety, and reduction in size and weight.

Although this embodiment shows an example where the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. A plurality of secondary batteries can be collectively referred to as an assembled battery.

An in-vehicle secondary battery includes a service plug or a circuit breaker that can cut off high voltage without the use of equipment in order to cut off electric power from a plurality of secondary batteries. The first battery 1301a is provided with such a service plug or a circuit breaker.

Electric power from the first batteries 1301a and 1301b is mainly used to rotate the motor 1304 and is also supplied to in-vehicle parts for 42 V (such as an electric power steering 1307, a heater 1308, and a defogger 1309) through a DC-DC circuit 1306. In the case where there is a rear motor 1317 for the rear wheels, the first battery 1301a is used to rotate the rear motor 1317.

The second battery 1311 supplies electric power to in-vehicle parts for 14 V (such as an audio 1313, power windows 1314, and lamps 1315) through a DC-DC circuit 1310.

The first battery 1301a is described with reference to FIG. 11B.

FIG. 11B illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode of each battery is fixed by a fixing portion 1414 made of an insulator. Although this embodiment shows an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414, a battery container box, or the like. Furthermore, the one electrode of each battery is electrically connected to a control circuit portion 1320 through a wiring 1421. The other electrode of each battery is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor may be referred to as a battery operating system or a battery oxide semiconductor (BTOS).

A metal oxide functioning as an oxide semiconductor is preferably used. For example, as the oxide, a metal oxide such as an In-M-Zn oxide (the element M is one or more of aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In-M-Zn oxide that can be used as the oxide is preferably a c-axis aligned crystal oxide semiconductor (CAAC-OS) or a cloud-aligned composite oxide semiconductor (CAC-OS). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. When an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction.

The control circuit portion 1320 preferably uses a transistor using an oxide semiconductor because the transistor using an oxide semiconductor can be used in a low-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is heated. The off-state current of the transistor using an oxide semiconductor is extremely low even at 150° C. independently of the temperature; meanwhile, the off-state current of the single crystal Si transistor largely depends on the temperature. For example, at 150° C., the off-state current of the single crystal Si transistor increases, and a sufficiently high current on/off ratio cannot be obtained. The control circuit portion 1320 can improve the degree of safety.

The control circuit portion 1320 that includes a memory circuit including a transistor using an oxide semiconductor can also function as an automatic control device for the secondary battery to resolve ten items of causes of instability, such as a micro short circuit. Examples of functions of resolving the ten items of causes of instability include prevention of overcharge, prevention of overcurrent, control of overheating during charge, maintenance of cell balance of an assembled battery, prevention of overdischarge, a battery indicator, automatic control of charging voltage and current amount according to temperature, control of the amount of charge current according to the degree of deterioration, abnormal behavior detection for a micro short circuit, and anomaly prediction regarding a micro short circuit; the control circuit portion 1320 has at least one of these functions. Furthermore, the automatic control device for the secondary battery can be extremely small in size.

A micro short circuit is one of internal short circuits and refers to a minute short circuit inside a secondary battery. One of the supposed causes of a micro short circuit is as follows. Uneven distribution of a positive electrode active material due to charging and discharging performed a plurality of times causes local current concentration at part of the positive electrode and part of the negative electrode; another supposed cause is generation of a by-product due to a side reaction.

It can be said that the control circuit portion 1320 not only detects a micro short circuit but also detects a terminal voltage of the secondary battery and controls the charging and discharging state of the secondary battery. For example, to prevent overcharge, the control circuit portion 1320 can turn off an output transistor of a charge circuit and an interruption switch substantially at the same time.

FIG. 11C shows an example of a block diagram of the battery pack 1415 illustrated in FIG. 11B.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the secondary battery used, and imposes the upper limit of current from the outside, the upper limit of output current to the outside, and the like. The range from the lower limit voltage to the upper limit voltage of the secondary battery falls within the recommended voltage range. When a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to including a switch having a Si transistor using single crystal silicon; the switch portion 1324 may be formed using a power transistor containing germanium (Ge), silicon germanium (SiGe), gallium arsenide (GaAs), gallium aluminum arsenide (GaAlAs), indium phosphide (InP), silicon carbide (SIC), zinc selenide (ZnSe), gallium nitride (GaN), gallium oxide (GaOₓ, where x is a real number greater than 0), or the like. A memory element using an OS transistor can be freely placed by being stacked over a circuit using a Si transistor, for example; hence, integration can be easy. The control circuit portion 1320 using an OS transistor can be stacked over the switch portion 1324 so that they can be integrated into one chip and can be reduced in size.

The first batteries 1301a and 1301b mainly supply electric power to in-vehicle parts for 42 V (for a high-voltage system), and the second battery 1311 supplies electric power to in-vehicle parts for 14 V (for a low-voltage system). A lead battery is usually used for the second battery 1311 due to cost advantage. There is an advantage that the second battery 1311 can be maintenance-free when a secondary battery is used; however, in the case of long-term use, for example three years or more, anomaly that cannot be determine at the time of manufacturing might occur. In particular, when the second battery 1311 that starts the inverter becomes inoperative, the motor cannot be started even when the first batteries 1301a and 1301b have remaining capacity in some cases. In the case where the second battery 1311 is a lead storage battery, the second battery is supplied with electric power from the first battery to constantly maintain a fully-charged state, and thus there is no possibility that the motor becomes inoperative as described above.

Although this embodiment describes an example in which secondary batteries are used as both the first battery 1301a and the second battery 1311, a lead storage battery, an all-solid-state battery, or an electric double layer capacitor may be used as the second battery 1311. When the secondary battery of the present invention is used as the above-described secondary battery, the above-described secondary battery can have high reliability. Furthermore, when the secondary battery of the present invention is used as the above-described secondary battery, the above-described secondary battery can have favorable low-temperature characteristics.

Regenerative energy generated by rolling of tires 1316 is transmitted to the motor 1304 through a gear 1305, and is stored in the second battery 1311 through a motor controller 1303, a battery controller 1302, and a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are preferably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an electronic control unit (ECU). The ECU is connected to a controller area network (CAN) provided in the electric motor vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, or a three-phase 200V outlet (50 KW), for example. Furthermore, charging can be performed by electric power supplied from external charge equipment with a contactless power feeding method or the like.

Next, examples in which the secondary battery of one embodiment of the present invention is mounted on a vehicle, typically a transport vehicle, will be described.

The use of secondary batteries in vehicles enables production of next-generation clean energy vehicles such as hybrid vehicles (HV), electric vehicles (EV), and plug-in hybrid vehicles (PHV). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft.

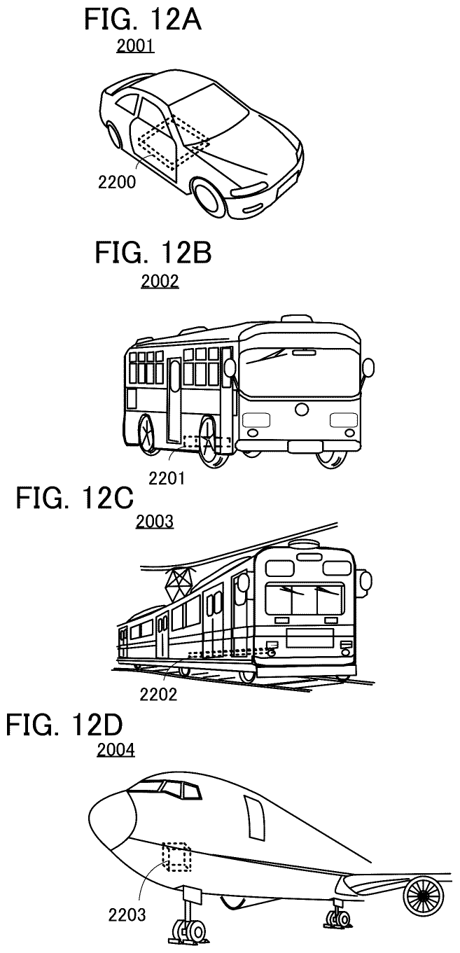

FIGS. 12A to 12D illustrate examples of transport vehicles using one embodiment of the present invention. An automobile 2001 illustrated in FIG. 12A is an electric vehicle that runs on the power of an electric motor. Alternatively, the automobile 2001 is a hybrid vehicle capable of driving using either an electric motor or an engine as appropriate. In the case where the secondary battery is mounted on the vehicle, the secondary battery described in the above embodiments is provided at one position or several positions. When the secondary battery of the present invention is used as the secondary battery mounted in the vehicle, the secondary battery mounted in the vehicle can have high reliability. Furthermore, when the secondary battery of the present invention is used as the above-described secondary battery, the above-described secondary battery can have favorable low-temperature characteristics.

The automobile 2001 illustrated in FIG. 12A includes a battery pack 2200, and the battery pack includes a battery module in which a plurality of secondary batteries are connected to each other. The battery pack 2200 preferably further includes a charge control device that is electrically connected to the battery module.

The automobile 2001 can be charged when the secondary battery included in the automobile 2001 is supplied with electric power through external charging equipment with a plug-in system, a contactless power feeding system, or the like. In charging, a given method such as CHAdeMO (registered trademark) or Combined Charging System can be employed as a charge method, the standard of a connector, or the like as appropriate. A charge equipment may be a charging station provided in a commerce facility or a power source in a house. For example, with the use of the plug-in technique, the power storage device mounted on the automobile 2001 can be charged by being supplied with electric power from outside. The charge can be performed by converting AC electric power into DC electric power through a converter such as an AC-DC converter.

Although not illustrated, the vehicle may include a power receiving device so that it can be charged by being supplied with electric power from an above-ground power transmitting device in a contactless manner. In the case of the contactless power feeding system, by fitting a power transmitting device in a road or an exterior wall, charging can be performed not only when the electric vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle is stopped and/or driven. To supply electric power in such a contactless manner, an electromagnetic induction method or a magnetic resonance method can be used.

FIG. 12B illustrates a large transporter 2002 having a motor controlled by electricity as an example of a transport vehicle. A battery module of the transporter 2002 includes, for example, a cell unit of four secondary batteries with a nominal voltage of 3.0 V or higher and 5.0 V or lower, and 48 cells are connected in series to have a maximum voltage of 170 V. A battery pack 2201 has the same function as that in FIG. 11B except, for example, the number of secondary batteries; thus, the description is omitted. When the secondary battery of the present invention is used as the secondary battery of the battery pack 2201, the secondary battery of the battery pack 2201 can have high reliability. Furthermore, when the secondary battery of the present invention is used as the secondary battery of the above-described battery pack 2201, the secondary battery of the battery pack 2201 can have favorable low-temperature characteristics.

FIG. 12C illustrates a large transport vehicle 2003 having a motor controlled by electricity as an example. A battery module of the transport vehicle 2003 has 100 or more secondary batteries with a nominal voltage of 3.0 V or higher and 5.0 V or lower connected in series to have a maximum voltage of 600 V. A battery pack 2202 has the same function as that in FIG. 11B except, for example, the number of secondary batteries configuring the battery module; thus, the description is omitted. When the secondary battery of the present invention is used as the secondary battery included in the module, the secondary battery included in the module can have high reliability. Furthermore, when the secondary battery of the present invention is used as the above-described secondary battery included in the module, the secondary battery included in the module can have favorable low-temperature characteristics.

FIG. 12D illustrates an aircraft 2004 having a combustion engine as an example. The aircraft 2004 illustrated in FIG. 12D is regarded as a transport vehicle because it has wheels for takeoff and landing, and includes a battery pack 2203 that includes a charge control device and a battery module configured by connecting a plurality of secondary batteries.

The battery module of the aircraft 2004 has eight 4 V secondary batteries connected in series, which has the maximum voltage of 32 V, for example. The battery pack 2203 has the same function as that in FIG. 11B except, for example, the number of secondary batteries configuring the battery module; thus, the description is omitted.

The contents in this embodiment can be combined with any of the contents in the other embodiments as appropriate.

### Embodiment 6

This embodiment will describe examples in which the secondary battery of one embodiment of the present invention is mounted on a vehicle such as a motorcycle and a bicycle.

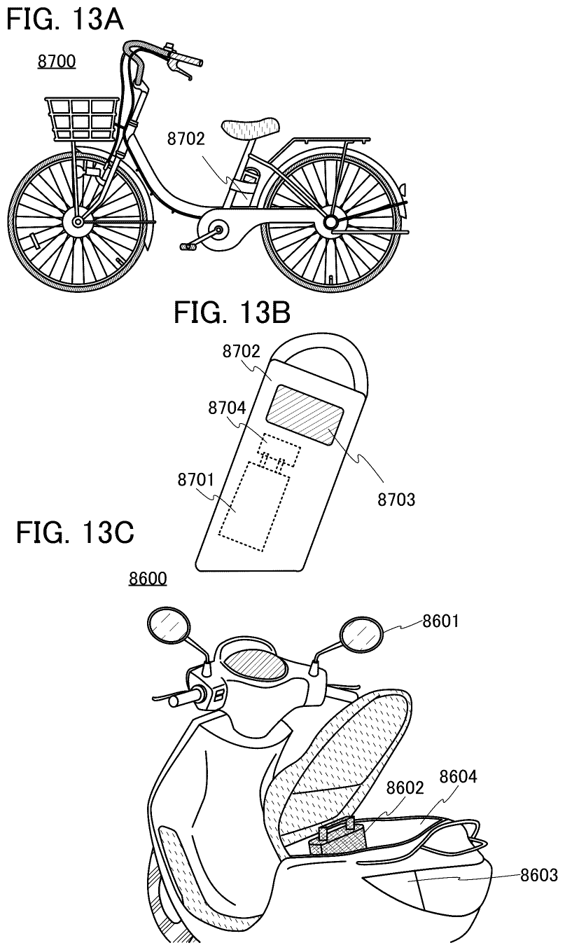

FIG. 13A illustrates an example of an electric bicycle using the secondary battery of one embodiment of the present invention. The secondary battery of one embodiment of the present invention can be used for an electric bicycle 8700 in FIG. 13A. The secondary battery of one embodiment of the present invention may include a protection circuit.

The electric bicycle 8700 is provided with a power storage device 8702. The power storage device 8702 can supply electric power to a motor that assists a rider. The power storage device 8702 is portable, and FIG. 13B illustrates the state where the power storage device 8702 is removed from the electric bicycle. A plurality of secondary batteries 8701 of one embodiment of the present invention is included in the power storage device 8702, and can display the remaining battery level and the like on a display portion 8703. When the secondary battery of the present invention is used as the secondary battery 8701, the secondary battery 8701 can have high reliability. Furthermore, when the secondary battery of the present invention is used as the secondary battery 8701, the secondary battery 8701 can have favorable low-temperature characteristics.

The power storage device 8702 includes a control circuit 8704 capable of charge control or anomaly detection for the secondary battery. The control circuit 8704 is electrically connected to a positive electrode and a negative electrode of the secondary battery 8701. The control circuit 8704 can contribute greatly to elimination of accidents due to secondary batteries, such as fires.

FIG. 13C illustrates an example of a motorcycle including the secondary battery of one embodiment of the present invention. A motor scooter 8600 illustrated in FIG. 13C includes a power storage device 8602, side mirrors 8601, and indicators 8603. The power storage device 8602 can supply electric power to the indicators 8603. When the secondary battery of the present invention is used as the secondary battery in the power storage device, the secondary battery in the power storage device can have high reliability. Furthermore, when the secondary battery of the present invention is used as the secondary battery in the power storage device, the secondary battery in the power storage device can have favorable low-temperature characteristics. In the motor scooter 8600 illustrated in FIG. 13C, the power storage device 8602 can be held in an under-seat storage unit 8604. The power storage device 8602 can be held in the under-seat storage unit 8604 even with a small size.

The contents in this embodiment can be combined with any of the contents in the other embodiments as appropriate.

### Embodiment 7

In this embodiment, examples of electronic devices each including the secondary battery of one embodiment of the present invention are described. Examples of the electronic device provided with the secondary battery include a television device (also referred to as a television or a television receiver), a monitor of a computer and the like, a digital camera, a digital video camera, a digital photo frame, a mobile phone (also referred to as a cellular phone or a mobile phone device), a portable game console, a portable information terminal, an audio reproducing device, and a large-sized game machine such as a pachinko machine. Examples of the portable information terminal include a laptop personal computer, a tablet terminal, an e-book reader, and a mobile phone.

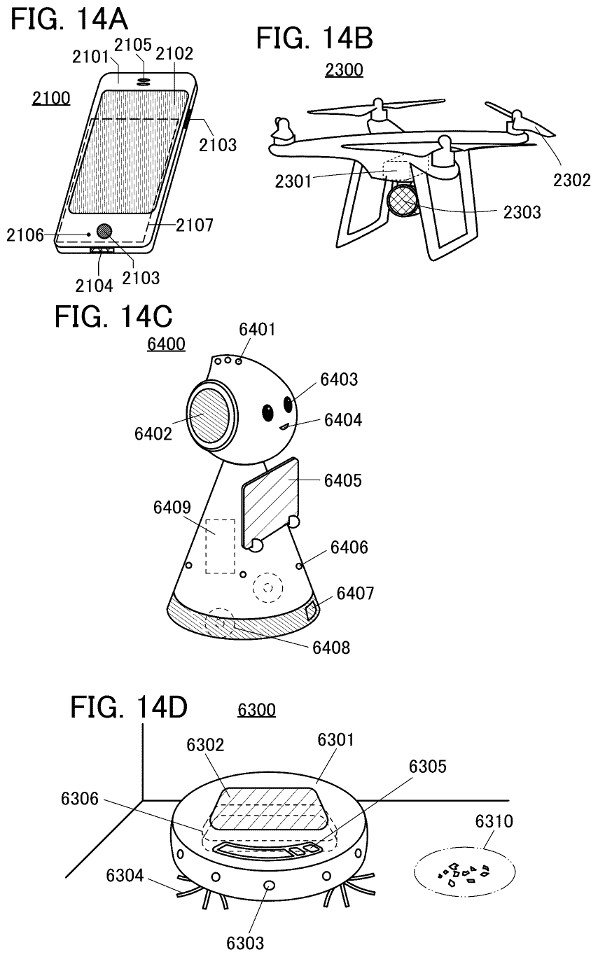

FIG. 14A illustrates an example of a mobile phone. A mobile phone 2100 includes a housing 2101 in which a display portion 2102 is incorporated, an operation button 2103, an external connection port 2104, a speaker 2105, a microphone 2106, and the like. The mobile phone 2100 includes a secondary battery 2107. When the secondary battery of the present invention is used as the secondary battery 2107, the secondary battery 2107 can have high reliability. Furthermore, when the secondary battery of the present invention is used as the secondary battery 2107, the secondary battery 2107 can have favorable low-temperature characteristics.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication between the mobile phone 2100 and a headset capable of wireless communication enables hands-free calling.

Moreover, the mobile phone 2100 includes the external connection port 2104, and data can be directly transmitted to and received from another information terminal via a connector. In addition, charge can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor; a touch sensor; a pressure sensitive sensor; or an acceleration sensor is preferably mounted, for example.

FIG. 14B illustrates an unmanned aircraft 2300 including a plurality of rotors 2302. The unmanned aircraft 2300 is also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. When the secondary battery of the present invention is used as the secondary battery 2301, the secondary battery 2301 can have high reliability. Furthermore, when the secondary battery of the present invention is used as the secondary battery 2301, the secondary battery 2301 can have favorable low-temperature characteristics.

FIG. 14C illustrates an example of a robot. A robot 6400 illustrated in FIG. 14C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charge and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. When the secondary battery of the present invention is used as the secondary battery 6409, the secondary battery 6409 can have high reliability. Furthermore, when the secondary battery of the present invention is used as the secondary battery 6409, the secondary battery 6409 can have favorable low-temperature characteristics.

FIG. 14D illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 can be self-propelled, detect dust 6310, and suck up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object that is likely to be caught in the brush 6304 (e.g., a wire) by image analysis, the rotation of the brush 6304 can be stopped. The cleaning robot 6300 further includes, in its inner region, the secondary battery 6306 of one embodiment of the present invention and a semiconductor device or an electronic component. When the secondary battery of the present invention is used as the secondary battery 6306, the secondary battery 6306 can have high reliability. Furthermore, when the secondary battery of the present invention is used as the secondary battery 6306, the secondary battery 6306 can have favorable low-temperature characteristics.

This embodiment can be implemented in appropriate combination with any of the other embodiments.

### Embodiment 8

In this embodiment, examples of space equipment including the secondary battery of one embodiment of the present invention are described.

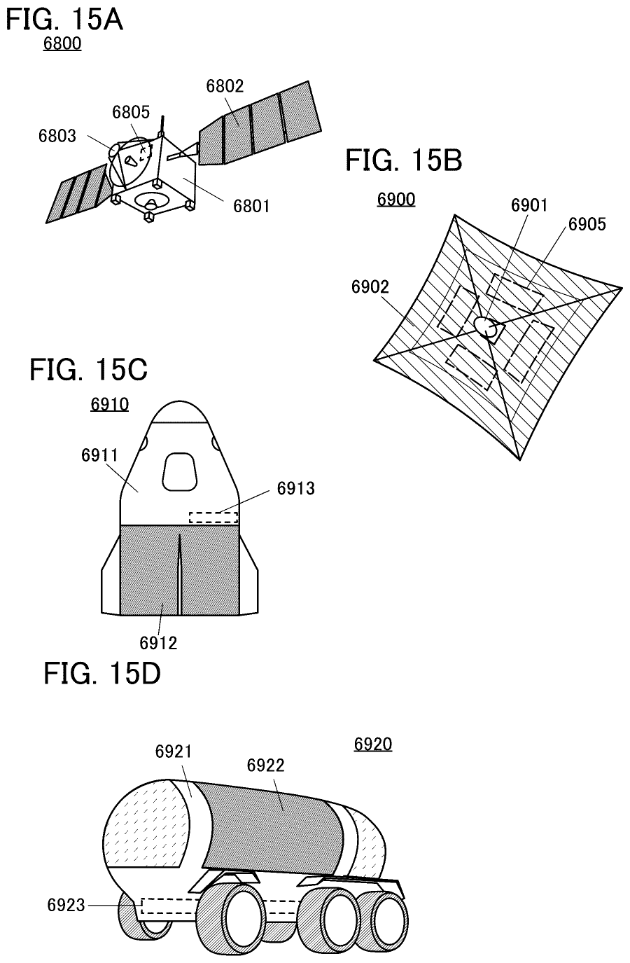

FIG. 15A illustrates an artificial satellite 6800 as an example of space equipment. The artificial satellite 6800 includes a body 6801, a solar panel 6802, an antenna 6803, and a secondary battery 6805. Such a solar panel is referred to as a solar cell module in some cases.

When the solar panel 6802 is irradiated with sunlight, electric power required for operation of the artificial satellite 6800 is generated. However, for example, in the situation where the solar panel is not irradiated with sunlight or the situation where the amount of sunlight with which the solar panel is irradiated is small, the amount of generated electric power is small. Accordingly, a sufficient amount of electric power required for operation of the artificial satellite 6800 might not be generated. In order to operate the artificial satellite 6800 even with a small amount of generated electric power, the artificial satellite 6800 is preferably provided with the secondary battery 6805. When the secondary battery of the present invention is used as the secondary battery 6805, the secondary battery 6805 can have high reliability. Furthermore, when the secondary battery of the present invention is used as the secondary battery 6805, the secondary battery 6805 can have favorable low-temperature characteristics.

The artificial satellite 6800 can generate a signal. The signal is transmitted through the antenna 6803, and can be received by a ground-based receiver or another artificial satellite, for example. When the signal transmitted by the artificial satellite 6800 is received, the position of a receiver that receives the signal can be measured. Thus, the artificial satellite 6800 can make up part of a satellite positioning system.

The artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can function as an earth observing satellite, for example.

FIG. 15B illustrates a probe 6900 including a solar sail as an example of space equipment. The probe 6900 includes a body 6901, a solar sail 6902, and a secondary battery 6905. When the secondary battery of the present invention is used as the secondary battery 6905, the secondary battery 6905 can have high reliability. Furthermore, when the secondary battery of the present invention is used as the secondary battery 6905, the secondary battery 6905 can have favorable low-temperature characteristics. When photons from the sun are incident on the surface of the solar sail 6902, the momentum is transmitted to the solar sail 6902. Hence, the surface of the solar sail 6902 preferably has a thin film with high reflectance and further preferably faces in the direction of the sun.

The solar sail 6902 may be designed such that the solar sail 6902 is furled in a small size until it goes beyond the earth's atmosphere, and is unfurled to have a large sheet-like shape as illustrated in FIG. 15B in the space beyond the earth's atmosphere (outer space).

FIG. 15C illustrates a spacecraft 6910 as an example of space equipment. The spacecraft 6910 includes a body 6911, a solar panel 6912, and a secondary battery 6913. When the secondary battery of the present invention is used as the secondary battery 6913, the secondary battery 6913 can have high reliability. Furthermore, when the secondary battery of the present invention is used as the secondary battery 6913, the secondary battery 6913 can have favorable low-temperature characteristics. The spacecraft body 6911 can include a pressurized cabin and an unpressurized cabin, for example. The pressurized cabin may be designed so that the crew can get into the cabin. Electric power that is generated by illumination of sunlight on the solar panel 6912 can be stored in the secondary battery 6913.

FIG. 15D illustrates a rover 6920 as an example of space equipment. The rover 6920 includes a body 6921 and a secondary battery 6923. When the secondary battery of the present invention is used as the secondary battery 6923, the secondary battery 6923 can have high reliability. Furthermore, when the secondary battery of the present invention is used as the secondary battery 6923, the secondary battery 6923 can have favorable low-temperature characteristics. The rover 6920 may include a solar panel 6922.

The rover 6920 may be designed so that the crew can get into the rover. Electric power that is generated by illumination of sunlight on the solar panel 6912 may be stored in the secondary battery 6923, or electric power generated by another power source such as a fuel cell or a radioisotope thermoelectric generator, for example, may be stored in the secondary battery 6923.

The contents of this embodiment can be combined with any of the contents in the other embodiments as appropriate.

This application is based on Japanese Patent Application Serial No. 2023-198879 filed with Japan Patent Office on Nov. 24, 2023, the entire contents of which are hereby incorporated by reference.

What is claimed is:

1. A secondary battery comprising:
a negative electrode active material layer;
a separator;
a carbon sheet between the negative electrode active material layer and the separator;
a dendrite between the negative electrode active material layer and the carbon sheet; and
a positive electrode active material layer,
wherein the negative electrode active material layer comprises a negative electrode active material,
wherein the negative electrode active material comprises one or more selected from graphite and silicon,
wherein a thickness of the carbon sheet is greater than or equal to 25 nm and less than or equal to 50 μm, and
wherein the dendrite comprises a portion along a plane of the carbon sheet.

2. The secondary battery according to claim 1, further comprising an electrolyte solution, wherein the electrolyte solution comprises FEC and MTFP.

3. The secondary battery according to claim 1, further comprising an electrolyte solution, wherein the electrolyte solution comprises ethylene carbonate, ethyl methyl carbonate, and dimethyl carbonate.

4. The secondary battery according to claim 1, further comprising an electrolyte solution, wherein the electrolyte solution comprises ethylene carbonate and diethyl carbonate.

5. The secondary battery according to claim 1, wherein the carbon sheet comprises a carbon nanotube.

6. A secondary battery comprising:
a negative electrode active material layer;
a separator;
a carbon sheet between the negative electrode active material layer and the separator;
a dendrite between the negative electrode active material layer and the carbon sheet; and
a positive electrode active material layer,
wherein the negative electrode active material layer comprises a negative electrode active material,
wherein the negative electrode active material comprises a lithium metal,
wherein a thickness of the carbon sheet is greater than or equal to 25 nm and less than or equal to 50 μm, and
wherein the dendrite comprises a portion along a plane of the carbon sheet.

7. The secondary battery according to claim 6, further comprising an electrolyte solution, wherein the electrolyte solution comprises ethylene carbonate and diethyl carbonate.

8. The secondary battery according to claim 6, wherein the carbon sheet comprises a carbon nanotube.

9. The secondary battery according to claim 6, further comprising an electrolyte solution, wherein the electrolyte solution comprises FEC and MTFP.

10. The secondary battery according to claim 6, further comprising an electrolyte solution, wherein the electrolyte solution comprises ethylene carbonate, ethyl methyl carbonate, and dimethyl carbonate.

11. A secondary battery comprising:
a negative electrode active material layer;
a carbon sheet;
a separator between the negative electrode active material layer and the carbon sheet;
a dendrite between the negative electrode active material layer and the separator; and
a positive electrode active material layer,
wherein the negative electrode active material layer comprises a negative electrode active material,
wherein a thickness of the carbon sheet is greater than or equal to 25 nm and less than or equal to 50 μm, and
wherein the dendrite comprises a portion along a plane of the carbon sheet.

12. The secondary battery according to claim 11, wherein the negative electrode active material comprises one or more selected from graphite and silicon.

13. The secondary battery according to claim 11, wherein the negative electrode active material comprises a lithium metal.

14. The secondary battery according to claim 11, further comprising an electrolyte solution, wherein the electrolyte solution comprises FEC and MTFP.

15. The secondary battery according to claim 11, further comprising an electrolyte solution, wherein the electrolyte solution comprises ethylene carbonate, ethyl methyl carbonate, and dimethyl carbonate.

16. The secondary battery according to claim 11, further comprising an electrolyte solution, wherein the electrolyte solution comprises ethylene carbonate and diethyl carbonate.

17. The secondary battery according to claim 11, wherein the carbon sheet comprises a carbon nanotube.
